(19) United States
(12) Patent Application Publication
(10) Pub. No.: US 2006/0217281 A1
(43) Pub. Date: Sep. 28, 2006

(54) Oxidation system containing a macrocyclic metal complex, the production thereof and its use

(76) Inventors: Uwe Vogt, Langenfeld (DE); Gunter Franke, Leichlingen (DE)

Correspondence Address: Jill Denesvich;Laxness Corporation, Law & Intellectual Property Department, 111 Ridc Park West Drive, Pittsburgh, PA, 15275-1112, US

(21) Appl. No.: 10/547,848

(22) PCT Filed: Mar. 5, 2004
(86) PCT No.: PCT/EP04/02274

§ 371 Date: Feb. 13, 2006

(30) Foreign Application Priority Data
Mar. 18, 2003 (DE) 10311766.0

(51) Int. Cl. C11D 3/39

(52) U.S. Cl. 510/312

(57) ABSTRACT

Disclosed is an oxidizing system comprising a macrocyclic metal complex, an oxidizing agent and an oxidation-enhancing compound. This oxidizing system is useful under a wide variety of reaction conditions for oxidizing oxidizable substances by contacting the oxidizable substance with the specific oxidizing system. An example of a possible use is in a process for removing excess, unfixed dye from textile materials after a dyeing.

The present invention relates to an oxidizing system comprising a macrocyclic metal complex, an oxidizing agent and an oxidation-enhancing compound and also a process for oxidizing oxidizable substances by contacting the oxidizable substance with the specific oxidizing system.

EP-A-0 918 840, U.S. Pat. No. 6,099,586 and WO-A-02/16330 disclose specific macro-cyclic metal complexes useful as bleach activators. Combined with a peroxide source, preferably hydrogen peroxide, these bleach activators make it possible to carry out oxidation reactions. Such oxidation reactions are carried out for example in paper bleaching, in the decolorization of colored wastewaters or in the desulfurization of motor fuels. The use in household laundry detergents for respectively removing and decolorizing soil on the laundry and in the wash liquor is also described. In all these applications, the use of the specific macrocyclic metal complexes leads to an improvement in the results compared with the sole treatment just with a peroxide source.

Owing to the multiplicity of possible oxidation reactions, there is an interest in providing improved oxidizing systems which can be as widely used as possible.

It has now been found that, surprisingly, the addition of specific oxidation-enhancing compounds to a macrocyclic metal complex and an oxidizing agent quite unexpectedly provides a distinct improvement in oxidizing performance.

The invention accordingly provides an oxidizing system comprising the three components
1) a macrocyclic metal complex of the general formula (I) 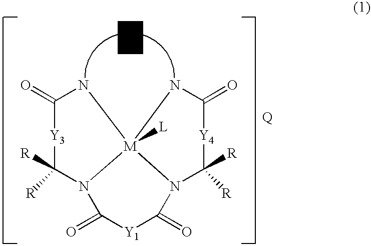
where
Y₁, Y₃ and Y₄ are each independently a single bond or a bridge member which contains 1, 2 or 3 carbon atoms in the bridge,
Y₂ is a bridge member having at least 1 carbon atom in the bridge,
R is independently in each occurrence hydrogen, alkyl, cycloalkyl, cycloalkenyl, alkenyl, aryl, alkynyl, alkylaryl, halogen, alkoxy, phenoxy, CH₂CF₃ or CF₃ or two R radicals which are bound to the same carbon atom combine to form a substituted or unsubstituted benzene, cycloalkyl or cycloalkenyl ring, the carbon atom to which the two R radicals are bound being part of the benzene, cycloalkyl or cycloalkenyl ring,
M is a transition metal in the oxidation states I, II, III, IV, V or VI or is selected from groups 6, 7, 8, 9, 10 and 11 of the periodic table,
Q is a counterion which balances the charge of the macrocyclic metal complex on a stoichiometric basis, and
L is a further ligand.
   2) an oxidizing agent, and
   3) an oxidation-enhancing compound.

Preferably in the general formula (1)
Y₁, Y₃ and Y₄ are each independently a (—CH₂—)ₓ group, where x is 1, 2 or 3 and one or more hydrogen atoms in the (—CH₂—)ₓ group may be substituted by an Rⁱ radical, Rⁱ being alkyl, cycloalkyl, cycloalkenyl, alkenyl, aryl, alkynyl, alkylaryl, halogen, alkoxy or phenoxy, or two Rⁱ radicals which are bound to two adjacent carbon atoms of the (—CH₂—)ₓ group combine to form a benzene, cycloalkyl or cycloalkenyl ring which may contain one or more hetero atoms, preferably oxygen, sulfur or nitrogen.

Preferably in the general formula (1), Y₂ is
a bridge member having 1, 2 or 3 carbon atoms in the bridge, preferably a (—CH₂—)_{y} group, where y is 1 or 2 and one or more hydrogen atoms in the (—CH₂—)ₓ group may be substituted by an Rⁱⁱ radical, Rⁱⁱ being alkyl, cycloalkyl, cycloalkenyl, alkenyl, aryl, alkynyl, alkylaryl, halogen, alkoxy or phenoxy, or two Rⁱⁱ radicals which are bound to two adjacent carbon atoms of the (—CH₂—)ₓ group combine to form an optionally substituted benzene, cycloalkyl or cycloalkenyl ring which may contain one or more hetero atoms, preferably oxygen, sulfur or nitrogen, preferably a benzene ring which may be substituted by electron-donating or electron-withdrawing radicals.
Preferably in the general formula (1) the R radicals are each independently hydrogen, C₁-C₈-alkyl, C₃-C₈-cycloalkyl, C₄-C₁₂-cycloalkenyl, C₂-C₈-alkenyl, C₆-C₁₄-aryl, C₂-C₁₂-alkynyl, C₁-C₁₂-alkylaryl, halogen, alkoxy, phenoxy, CH₂CF₃ or CF₃ or two R radicals which are bound to the same carbon atom combine to form a substituted or unsubstituted benzene, C₃-C₈-cycloalkyl or C₄-C₁₂-cycloalkenyl ring, the carbon atom to which the two R radicals are bound being part of the benzene, cycloalkyl or cycloalkenyl ring.

The M metal in the general formula (1) represents a transition metal having the oxidation states I, II, III, IV, V or VI or is selected from groups 6, 7, 8, 9, 10 or 11 of the periodic table. Preferably the M metal represents Cr, Mo, W, Mn, Fe, Ru, Os, Co, Rh, Ir, Ni, Pd and/or Pt. Mixtures of metals of the aforementioned oxidation states or from the identified groups of the periodic table are likewise possible.

In the general formula (1) Q is a counterion which balances the charge of the macrocyclic metal complex on a stoichiometric basis. The metal-ligand complex is typically negative, preferably −1. Consequently, the counterion generally has a positive charge and given a preferred negative charge of −1 is accordingly +1.

Suitably, Q is an alkali metal counterion, preferably potassium, lithium or sodium, NRⁱⁱⁱ₄⁺ or PRⁱⁱⁱ₄⁺, where every Rⁱⁱⁱ may independently be hydrogen, alkyl, aryl, alkylaryl, alkenyl or joins to form a cycloalkyl, cycloalkenyl or an aryl ring which optionally contains one or more hetero atoms, preferably oxygen, sulfur or nitrogen.

L is any further ligand which can attach to M. Preferably, L is a labile ligand, especially H₂O, Cl or CN.

The aforementioned preferred and particularly preferred meanings for Y₁-Y₄, R, Rⁱ, Rⁱⁱ, Rⁱⁱⁱ, Q and L may be combined in any desired manner.

The oxidizing system of the present invention preferably utilizes macrocyclic metal complexes of the general formula (1A) 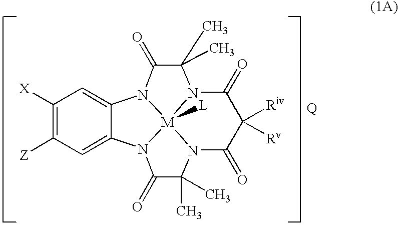
where
X and Z are each independently hydrogen, electron-donating or electron-withdrawing groups,
R^{iv} and R^{v} are each independently hydrogen, alkyl, cycloalkyl, cycloalkenyl, alkenyl, aryl, alkynyl, alkylaryl, halogen, alkoxy or phenoxy radicals or combine to form a cycloalkyl or cycloalkenyl ring which may contain one or more hetero atoms,
M is a transition metal of the oxidation states I, II, III, IV, V or VI or is selected from groups 6, 7, 8, 9, 10 or 11 of the periodic table,
Q is a counterion which balances the charge of the macrocyclic metal complex on a stoichiometric basis, and
L is a further ligand.

In the macrocyclic metal complex of the formula (IA) X and Z may each be independently hydrogen or electron-donating or electron-withdrawing radicals. Electron-donating or electron-withdrawing radicals change the electron density of the metal-ligand complex and thus influence its reactivity.

Suitable electron-withdrawing radicals are for example halogens, preferably chlorine, bromine or iodine, more preferably chlorine, SO₃⁻, OSO₃⁻, OSO₃R^{vi} (where R^{vi} is hydrogen, alkyl, aryl or alkylaryl) or NO₂⁻.

Suitable electron-donating radicals are for example C₁-C₈-alkoxy, preferably methoxy, ethoxy, propoxy and butoxy, C₁-C₈-alkyl, preferably methyl, ethyl, propyl, n-butyl and tert-butyl, and hydrogen.

In the macrocyclic metal complex of the formula (IA) R^{iv} and R^{v} are each independently hydrogen, alkyl, cycloalkyl, cycloalkenyl, alkenyl, aryl, alkynyl, halogen, alkoxy or phenoxy radicals. R^{iv} and R^{v} are preferably each independently alkyl, particularly preferably C₁-C₅-alkyl. More preferably R^{iv} and R^{v} are both identically methyl or ethyl. Even more preferably, R^{iv} and R^{v} combine to form a cycloalkyl ring, especially a cyclopentyl or cyclohexyl ring, or a cycloalkenyl ring. This cycloalkyl or cycloalkenyl ring may contain one or more hetero atoms, preferably oxygen, sulfur or nitrogen.

The preparation of the macrocyclic metal complexes present in the inventive oxidizing system is described in EP-A-918 840, U.S. Pat. No. 6,099,586 and WO-A-02/16330, each of which is hereby explicitly incorporated herein by reference.

The oxidizing agent can be any organic or inorganic oxidizing agent. A peroxy compound is typically used. Suitable peroxy compounds are hydrogen peroxide, hydrogen peroxide adducts, compounds capable of releasing or generating hydrogen peroxide in aqueous solution, organic peroxides, persulfates, perphosphates and persilicates.

Hydrogen peroxide adducts include alkali metal, preferably sodium, lithium or potassium, carbonate peroxyhydrate and also urea peroxide.

Compounds capable of generating hydrogen peroxide in aqueous solution include alkali metal, preferably sodium, potassium or lithium, perborate (as mono- or tetrahydrate). Such perborates are commercially available.

Alternatively, an alcohol oxidase and its appropriate alcohol substrate can be used as peroxide source.

Organic peroxides include benzoyl and cumene hydroperoxides.

Persulfates include peroxymonosulfate and Carot's acid.

Particularly preferred oxidizing agents are hydrogen peroxide and sodium perborate.

The oxidation-enhancing compounds (“mediator”) are aliphatic, cycloaliphatic, heterocyclic or aromatic compounds having at least one OH, NO, NOH, HRN—OH functionality or mixtures thereof.

Such compounds and their preparation are described in EP-A-0 885 868, WO-A-97/06244 and WO-A-96/12845.

Examples of such compounds are the hereinbelow identified compounds of the formula (I), (II), (III) and (IV), the compounds of the formulae (II), (III) and (IV) being preferred and the compounds of the formulae (III) and (IV) being particularly preferred.

Compounds of the general formula (I) are: 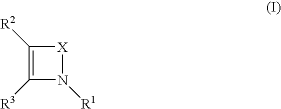
where X represents (—N═N—), (—N═CR⁴—)ₚ, (—CR⁴═N—)ₚ, (—CR⁵═CR⁶)ₚ, 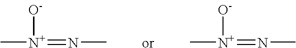
and p is 1 or 2,
where the radicals R¹ to R⁶ be the same or different and may each independently denote: hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, sulfo and also esters and salts thereof, sulfamoyl, carbamoyl, phospho, phosphono, phosphonooxy and also salts and esters thereof, where the amino, carbamoyl and sulfamoyl groups of the radicals R¹ to R⁶ may be unsubstituted or singly or doubly hydroxyl, C₁-C₃-alkyl or C₁-C₃-alkoxy substituted, and where the radicals R² and R³ may combine to form a conjoint group -A- and -A- is (—CR⁷═CR⁸—CR⁹═CR¹⁰—) or (—CR¹⁰═CR⁹—CR⁸═CR⁷—).

The radicals R⁷ to R¹⁰ may be the same or different and each independently denote: hydrogen, halogen, hydroxyl, formyl, carboxyl and also salts and esters thereof, amino, nitro, C₁-C₁₂-alkyl, C₁-C₆-alkyloxy, carbonyl-C₁-C₅-alkyl, phenyl, aryl, sulfo and also esters and salts thereof, sulfamoyl, carbamoyl, phospho, phosphono, phosphonooxy and also salts and esters thereof, where the amino, carbamoyl and sulfamoyl groups of the radicals R⁷ to R¹⁰ may be unsubstituted or singly or doubly hydroxyl, C₁-C₃-alkyl or C₁-C₃-alkoxy substituted, and where the C₁-C₁₂-alkyl, C₁-C₆-alkyloxy, carbonyl-C₁-C₆-alkyl, phenyl and aryl groups of the radicals R⁷ to R¹⁰ may be unsubstituted or singly or multiply R¹¹ substituted and where R¹¹ denotes one of the following groups: hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, aryl, sulfo and also esters and salts thereof, where the carbamoyl, sulfamoyl and amino groups of the R¹¹ radical may be unsubstituted or singly or doubly R¹² substituted and R¹² may denote one of the following groups: hydrogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl or aryl.

Examples of the identified compounds of the general formula (I) are:
1-hydroxy-1,2,3-triazole-4,5-dicarboxylic acid
1-phenyl-1H-1,2,3-triazole 3-oxide
5-chloro-1-phenyl-1H-1,2,3-triazole 3-oxide
5-methyl-1-phenyl-1H-1,2,3-triazole 3-oxide
4-(2,2-dimethylpropanoyl)-1-hydroxy-1H-1,2,3-triazole
4-hydroxy-2-phenyl-2H-1,2,3-triazole 1-oxide
2,4,5-triphenyl-2H-1,2,3-triazole 1-oxide
1-benzyl-1H-1,2,3-triazole 3-oxide
1-benzyl-4-chloro-1H-1,2,3-triazole 3-oxide
1-benzyl-4-bromo-1H-1,2,3-triazole 3-oxide
1-benzyl-4-methoxy-1H-1,2,3-triazole 3-oxide

Compounds of the general formula (II) are: 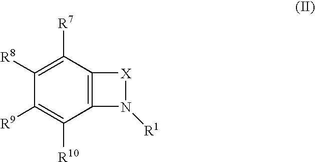
where X represents (—N═N—), (—N═CR⁴—)ₚ, (—CR⁴═N—)ₚ, (—CR⁵═CR⁶)ₚ, 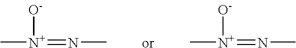
and p is 1 or 2.

The radicals R¹ and R⁴ to R¹⁰ may be the same or different and denote one of the following groups: hydrogen, halogen, hydroxyl, formyl, carboxyl and also salts and esters thereof, amino, nitro, C₁-C₁₂-alkyl, C₁-C₅-alkyloxy, carbonyl-C₁-C₆-alkyl, phenyl, aryl, sulfo and also esters and salts thereof, sulfamoyl, carbamoyl, phospho, phosphono, phosphonooxy and also salts and esters thereof, where the amino, carbamoyl and sulfamoyl groups of the radicals R¹ and R⁴ to R¹⁰ may also be unsubstituted or singly or doubly hydroxyl, C₁-C₃-alkyl or C₁-C₃-alkoxy substituted and where the C₁-C₁₂-alkyl, C₁-C₆-alkyloxy, carbonyl-C₁-C₆-alkyl, phenyl, aryl and aryl-C₁-C₆-alkyl groups of the radicals R¹ and R⁴ to R¹⁰ may be unsubstituted or singly or multiply R¹² substituted and where R¹² may denote: hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, aryl, sulfo, sulfeno, sulfino and also esters and salts thereof, where the carbamoyl, sulfamoyl and amino groups of the R² radical may be unsubstituted or singly or doubly R¹³ substituted and where R¹³ may denote one of the following groups: hydrogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl or aryl.

Examples of the identified compounds of the general formula (II) are:

1-Hydroxybenzimidazoles

1-Hydroxybenzimidazole-2-carboxylic acid
1-Hydroxybenzimidazole
2-Methyl-1-hydroxybenzimidazole
2-Phenyl-1-hydroxybenzimidazole
   1-Hydroxyindoles
2-Phenyl-1-hydroxyindole

Substances of the general formula (III) are: 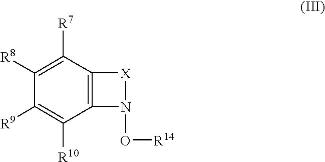
where X represents (—N═N—), (—N═CR⁴—)ₘ, (—CR⁴═N—)ₘ, (—CR⁵═CR⁶—)ₘ, 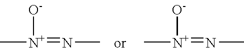
and m is 1 or 2.

The radicals R⁷ to R¹⁰ and R⁴ to R⁶ are each subject to the above remarks.

R¹⁴ may denote: -M, where M denotes hydrogen, alkali, preferably lithium, sodium or potassium, alkaline earth, preferably calcium or magnesium, ammonium, C₁-C₄-alkylammonium or C₁-C₄-alkanolammonium, C₁-C₁₀-alkyl, C₁-C₁₀-alkylcarbonyl, where C₁-C₁₀-alkyl and C₁-C₁₀-alkylcarbonyl may be unsubstituted or singly or multiply R¹⁵ substituted, where R¹⁵ may denote one of the following groups: hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, sulfo, and also esters and salts thereof, sulfamoyl, carbamoyl, phospho, phosphono, phosphonooxy and also salts and esters thereof, where the amino, carbamoyl and sulfamoyl groups of the R¹⁵ radical may be unsubstituted or singly or doubly hydroxyl, C₁-C₃-alkyl or C₁-C₃-alkoxy substituted.

Of the substances of the formula (III) it is in particular derivatives of 1-hydroxybenzotriazole and of the tautomeric benzotriazole 1-oxide and also esters and salts thereof which are preferred (compounds of the formula (IV)) 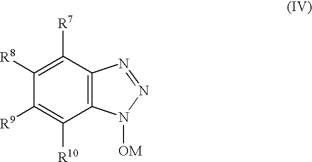
where
M denotes hydrogen, alkali, preferably lithium, sodium or potassium, alkaline earth, preferably calcium or magnesium, ammonium, C₁-C₄-alkylammonium or C₁-C₄-alkanolammonium.

The radicals R⁷ to R¹⁰ may be the same or different and each independently denote one of the following groups: hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, sulfo and also esters and salts thereof, sulfamoyl, carbamoyl, phospho, phosphono, phosphonooxy and also salts and esters thereof, where the amino, carbamoyl and sulfamoyl groups of the radicals R⁷ to R¹⁰ may be unsubstituted or singly or doubly hydroxyl, C₁-C₃-alkyl or C₁-C₃-alkoxy substituted, and where the C₁-C₁₂-alkyl, C₁-C₆-alkyloxy, carbonyl-C₁-C₅-alkyl, phenyl and aryl groups of the radicals R⁷ to R¹⁰ may be unsubstituted or singly or multiply R¹⁶ substituted and where R¹⁶ may denote one of the following groups: hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, aryl, sulfo, sulfeno, sulfino and also esters and salts thereof, where the carbamoyl, sulfamoyl and amino groups of the R¹⁶ radical may be unsubstituted or singly or doubly R¹⁷ substituted and R¹⁷ may denote one of the following groups: hydrogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl or aryl.

Examples of the identified compounds of the general formula (III) are:

1-Hydroxybenzotriazoles

1-Hydroxybenzotriazole
1-Hydroxybenzotriazole, sodium salt
1-Hydroxybenzotriazole, potassium salt
1-Hydroxybenzotriazole, lithium salt
1-Hydroxybenzotriazole, ammonium salt
1-Hydroxybenzotriazole, calcium salt
1-Hydroxybenzotriazole, magnesium salt
1-Hydroxybenzotriazole-4-sulfonic acid
1-Hydroxybenzotriazole-4-sulfonic acid, sodium salt
1-Hydroxybenzotriazole-4-sulfonic acid, potassium salt
1-Hydroxybenzotriazole-4-sulfonic acid, ammonium salt
1-Hydroxybenzotriazole-5-sulfonic acid
1-Hydroxybenzotriazole-5-sulfonic acid, sodium salt
1-Hydroxybenzotriazole-5-sulfonic acid, potassium salt
1-Hydroxybenzotriazole-5-sulfonic acid, ammonium salt
1-Hydroxybenzotriazole-6-sulfonic acid
1-Hydroxybenzotriazole-6-sulfonic acid, sodium salt
1-Hydroxybenzotriazole-6-sulfonic acid, potassium salt
1-Hydroxybenzotriazole-6-sulfonic acid, ammonium salt
1-Hydroxybenzotriazole-7-sulfonic acid
1-Hydroxybenzotriazole-7-sulfonic acid, sodium salt
1-Hydroxybenzotriazole-7-sulfonic acid, potassium salt
1-Hydroxybenzotriazole-7-sulfonic acid, ammonium salt
1-Hydroxybenzotriazole-6-sulfonic acid, monosodium salt
1-Hydroxybenzotriazole-4-carboxylic acid
1-Hydroxybenzotriazole-4-carboxylic acid, sodium salt
1-Hydroxybenzotriazole-4-carboxylic acid, potassium salt
1-Hydroxybenzotriazole-4-carboxylic acid, ammonium salt
1-Hydroxybenzotriazole-5-carboxylic acid
1-Hydroxybenzotriazole-5-carboxylic acid, sodium salt
1-Hydroxybenzotriazole-5-carboxylic acid, potassium salt
1-Hydroxybenzotriazole-5-carboxylic acid, ammonium salt
1-Hydroxybenzotriazole-6-carboxylic acid
1-Hydroxybenzotriazole-6-carboxylic acid, sodium salt
1-Hydroxybenzotriazole-6-carboxylic acid, potassium salt 01-Hydroxybenzotriazole-6-carboxylic acid, ammonium salt
1-Hydroxybenzotriazole-7-carboxylic acid
1-Hydroxybenzotriazole-7-carboxylic acid, sodium salt
1-Hydroxybenzotriazole-7-carboxylic acid, potassium salt
1-Hydroxybenzotriazole-7-carboxylic acid, ammonium salt
1-Hydroxybenzotriazole-6-N-phenylcarboxamide
5-Ethoxy-6-nitro-1-hydroxybenzotriazole
4-Ethyl-7-methyl-6-nitro-1-hydroxybenzotriazole
2,3-Bis-(4-ethoxy-phenyl)-4,6-dinitro-2,3-dihydro-1-hydroxybenzotriazole
2,3-Bis-(2-bromo-4-methyl-phenyl)-4,6-dinitro-2,3-dihydro-1-hydroxybenzo-triazole
2,3-Bis-(4-bromo-phenyl)-4,6-dinitro-2,3-dihydro-1-hydroxybenzotriazole
2,3-Bis-(4-carboxy-phenyl)-4,6-dinitro-2,3-dihydro-1-hydroxybenzotriazole
4,6-Bis-(trifluoromethyl)-1-hydroxybenzotriazole
5-Bromo-1-hydroxybenzotriazole
6-Bromo-1-hydroxybenzotriazole
4-Bromo-7-methyl-1-hydroxybenzotriazole
5-Bromo-7-methyl-6-nitro-1-hydroxybenzotriazole
4-Bromo-6-nitro-1-hydroxybenzotriazole
6-Bromo-4-nitro-1-hydroxybenzotriazole
4-Chloro-1-hydroxybenzotriazole
5-Chloro-1-hydroxybenzotriazole
6-Chloro-1-hydroxybenzotriazole
6-Chloro-5-isopropyl-1-hydroxybenzotriazole
5-Chloro-6-methyl-1-hydroxybenzotriazole
6-Chloro-5-methyl-1-hydroxybenzotriazole
4-Chloro-7-methyl-6-nitro-1-hydroxybenzotriazole
4-Chloro-5-methyl-1-hydroxybenzotriazole
5-Chloro-4-methyl-1-hydroxybenzotriazole
4-Chloro-6-nitro-1-hydroxybenzotriazole
6-Chloro-4-nitro-1-hydroxybenzotriazole
7-Chloro-1-hydroxybenzotriazole
6-Diacetylamino-1-hydroxybenzotriazole
2,3-Dibenzyl-4,6-dinitro-2,3-dihydro-1-hydroxybenzotriazole
4,6-Dibromo-1-hydroxybenzotriazole
4,6-Dichloro-1-hydroxybenzotriazole
5,6-Dichloro-1-hydroxybenzotriazole
4,5-Dichloro-1-hydroxybenzotriazole
4,7-Dichloro-1-hydroxybenzotriazole
5,7-Dichloro-6-nitro-1-hydroxybenzotriazole
5,6-Dimethoxy-1-hydroxybenzotriazole
2,3-Di-[2]naphthyl-4,6-dinitro-2,3-dihydro-1-hydroxybenzotriazole
4,6-Dinitro-1-hydroxybenzotriazole
4,6-Dinitro-2,3-diphenyl-2,3-dihydro-1-hydroxybenzotriazole
4,6-Dinitro-2,3-di-p-tolyl-2,3-dihydro-1-hydroxybenzotriazole
5-Hydrazino-7-methyl-4-nitro-1-hydroxybenzotriazole
5,6-Dimethyl-1-hydroxybenzotriazole
4-Methyl-1-hydroxybenzotriazole
5-Methyl-1-hydroxybenzotriazole
6-Methyl-1-hydroxybenzotriazole
5-(1-Methylethyl)-1-hydroxybenzotriazole
4-Methyl-6-nitro-1-hydroxybenzotriazole
6-Methyl-4-nitro-1-hydroxybenzotriazole
5-Methoxy-1-hydroxybenzotriazole
6-Methoxy-1-hydroxybenzotriazole
7-Methyl-6-nitro-1-hydroxybenzotriazole
4-Nitro-1-hydroxybenzotriazole
6-Nitro-1-hydroxybenzotriazole
6-Nitro-4-phenyl-1-hydroxybenzotriazole
5-Phenylmethyl-1-hydroxybenzotriazole
4-Trifluoromethyl-1-hydroxybenzotriazole
5-Trifluoromethyl-1-hydroxybenzotriazole
6-Trifluoromethyl-1-hydroxybenzotriazole
4,5,6,7-Tetrachloro-1-hydroxybenzotriazole
4,5,6,7-Tetrafluoro-1-hydroxybenzotriazole
6-Tetrafluoroethyl-1-hydroxybenzotriazole
4,5,6-Trichloro-1-hydroxybenzotriazole
4,6,7-Trichloro-1-hydroxybenzotriazole
6-Sulfamido-1-hydroxybenzotriazole
6-N,N-Diethyl-sulfamido-1-hydroxybenzotriazole
6-N-Methylsulfamido-1-hydroxybenzotriazole
6-(1H-1,2,4-Triazol-1-ylmethyl)-1-hydroxybenzotriazole
6-(5,6,7,8-Tetrahydroimidazo-[1,5-a]-pyridin-5-yl)-1-hydroxybenzotriazole
6-(Phenyl-1H-1,2,4-triazol-1-ylmethyl)-1-hydroxybenzotriazole
6-[(5-Methyl-1H-imidazo-1-yl)-phenylmethyl]-1-hydroxybenzotriazole
6-[(4-Methyl-1H-imidazo-1-yl)-phenylmethyl]-1-hydroxybenzotriazole
6-[(2-Methyl-1H-imidazo-1-yl)-phenylmethyl]-1-hydroxybenzotriazole
6-(1H-Imidazol-1-yl-phenylmethyl)-1-hydroxybenzotriazole
5-(1H-Imidazol-1-yl-phenylmethyl)-1-hydroxybenzotriazole
6-[1-(1H-Imidazol-1-yl)-ethyl]-1-hydroxybenzotriazole monohydrochloride
   3H-Benzotriazole 1-oxides
3H-Benzotriazole 1-oxide
6-Acetyl-3H-benzotriazole 1-oxide
5-Ethoxy-6-nitro-3H-benzotriazole 1-oxide
4-Ethyl-7-methyl-6-nitro-3H-benzotriazole 1-oxide
6-Amino-3,5-dimethyl-3H-benzotriazole 1-oxide
6-Amino-3-methyl-3H-benzotriazole 1-oxide
5-Bromo-3H-benzotriazole 1-oxide
6-Bromo-3H-benzotriazole 1-oxide
4-Bromo-7-methyl-3H-benzotriazole 1-oxide
5-Bromo-4-chloro-6-nitro-3H-benzotriazole 1-oxide
4-Bromo-6-nitro-3H-benzotriazole 1-oxide
6-Bromo-4-nitro-3H-benzotriazole 1-oxide
5-Chloro-3H-benzotriazole 1-oxide
6-Chloro-3H-benzotriazole 1-oxide
4-Chloro-6-nitro-3H-benzotriazole 1-oxide
4,6-Dibromo-3H-benzotriazole 1-oxide
4,6-Dibromo-3-methyl-3H-benzotriazole 1-oxide
4,6-Dichloro-3H-benzotriazole 1-oxide
4,7-Dichloro-3H-benzotriazole 1-oxide
5,6-Dichloro-3H-benzotriazole 1-oxide
4,6-Dichloro-3-methyl-3H-benzotriazole 1-oxide
5,7-Dichloro-6-nitro-3H-benzotriazole 1-oxide
3,6-Dimethyl-6-nitro-3H-benzotriazole 1-oxide
3,5-Dimethyl-6-nitro-3H-benzotriazole 1-oxide
3-Methyl-3H-benzotriazole 1-oxide
5-Methyl-3H-benzotriazole 1-oxide
6-Methyl-3H-benzotriazole 1-oxide
6-Methyl-4-nitro-3H-benzotriazole 1-oxide
7-Methyl-6-nitro-3H-benzotriazole 1-oxide
5-Chloro-6-nitro-3H-benzotriazole 1-oxide
   2H-Benzotriazole 1-oxides
2-(4-Acetoxy-phenyl)-2H-benzotriazole 1-oxide
6-Acetylamino-2-phenyl-2H-benzotriazole 1-oxide
2-(4-Ethyl-phenyl)-4,6-dinitro-2H-benzotriazole 1-oxide
2-(3-Aminophenyl)-2H-benzotriazole 1-oxide
2-(4-Aminophenyl)-2H-benzotriazole 1-oxide
6-Amino-2-phenyl-2H-benzotriazole 1-oxide
5-Bromo-4-chloro-6-nitro-2-phenyl-2H-benzotriazole 1-oxide
2-(4-Bromophenyl)-2H-benzotriazole 1-oxide
5-Bromo-2-phenyl-2H-benzotriazole 1-oxide
6-Bromo-2-phenyl-2H-benzotriazole 1-oxide
2-(4-Bromophenyl)-4,6-dinitro-2H-benzotriazole 1-oxide
2-(4-Bromophenyl)-6-nitro-2H-benzotriazole 1-oxide
5-Chloro-2-(2-chlorophenyl)-2H-benzotriazole 1-oxide
5-Chloro-2-(3-chlorophenyl)-2H-benzotriazole 1-oxide
5-Chloro-2-(2-chlorophenyl)-2H-benzotriazole 1-oxide
5-Chloro-2-(3-chlorophenyl)-2H-benzotriazole 1-oxide
5-Chloro-2-(2,4-dibromophenyl)-2H-benzotriazole 1-oxide
5-Chloro-2-(2,5-dimethylphenyl)-2H-benzotriazole 1-oxide
5-Chloro-2-(4-nitrophenyl)-2H-benzotriazole 1-oxide
5-Chloro-6-nitro-2-phenyl-2H-benzotriazole 1-oxide
2-[4-(4-Chloro-3-nitro-phenylazo)-3-nitrophenyl]-4,6-dinitro-2H-benzotriazole 1-oxide
2-(3-Chloro-4-nitro-phenyl)-4,6-dinitro-2H-benzotriazole 1-oxide
2-(4-Chloro-3-nitrophenyl)-4,6-dinitro-2H-benzotriazole 1-oxide
4-Chloro-6-nitro-2-p-tolyl-2H-benzotriazole 1-oxide
5-Chloro-6-nitro-2-p-tolyl-2H-benzotriazole 1-oxide
6-Chloro-4-nitro-2-p-tolyl-2H-benzotriazole 1-oxide
2-(2-Chlorophenyl)-2H-benzotriazole 1-oxide
2-(3-Chlorophenyl)-2H-benzotriazole 1-oxide
2-(4-Chlorophenyl)-2H-benzotriazole 1-oxide
5-Chloro-2-phenyl-2H-benzotriazole 1-oxide
2-[4-(4-Chlorophenylazo)-3-nitrophenyl]-4,6-dinitro-2H-benzotriazole 1-oxide
2-(2-Chlorophenyl)-4,6-dinitro-2H-benzotriazole 1-oxide
2-(3-Chlorophenyl)-4,6-dinitro-2H-benzotriazole 1-oxide
2-(4-Chlorophenyl)-4,6-dinitro-2H-benzotriazole 1-oxide
2-{4-[N′-(3-Chlorophenyl)-hydrazino]-3-nitrophenyl}4,6-dinitro-2H-benzo-triazole 1-oxide
2-{4-[N′-(4-Chlorophenyl)-hydrazino]-3-nitrophenyl}4,6-dinitro-2H-benzo-triazole 1-oxide
2-(2-Chlorophenyl)-6-methyl-2H-benzotriazole 1-oxide
2-(3-Chlorophenyl)-6-methyl-2H-benzotriazole 1-oxide
2-(4-Chlorophenyl)-6-methyl-2H-benzotriazole 1-oxide
2-(3-Chlorophenyl)-6-nitro-2H-benzotriazole 1-oxide
2-(4-Chlorophenyl)-6-nitro-2H-benzotriazole 1-oxide
2-(4-Chlorophenyl)-6-picrylazo-2H-benzotriazole 1-oxide
5-Chloro-2-(2,4,5-trimethylphenyl)-2H-benzotriazole 1-oxide
4,5-Dibromo-6-nitro-2-p-tolyl-2H-benzotriazole 1-oxide
4,5-Dichloro-6-nitro-2-phenyl-2H-benzotriazole 1-oxide
4,5-Dichloro-6-nitro-2-p-tolyl-2H-benzotriazole 1-oxide
4,7-Dichloro-6-nitro-2-p-tolyl-2H-benzotriazole 1-oxide
4,7-Dimethyl-6-nitro-2-phenyl-2H-benzotriazole 1-oxide
2-(2,4-Dimethylphenyl)-4,6-dinitro-benzotriazole 1-oxide
2-(2,5-Dimethylphenyl)-4,6-dinitro-2H-benzotriazole 1-oxide
2-(2,4-Dimethylphenyl)-6-nitro-2H-benzotriazole 1-oxide
2-(2,5-Dimethylphenyl)-6-nitro-2H-benzotriazole 1-oxide
4,6-Dinitro-2-[3-nitro-4-(N′-phenylhydrazino)-phenyl-]-1-2H-benzotriazole 1-oxide
4,6-Dinitro-2-[4-nitro-4-(N′-phenylhydrazino)-phenyl-]-2H-benzotriazole
1-oxide
4,6-Dinitro-2-phenyl-2H-benzotriazole 1-oxide
2-(2,4-Dinitrophenyl)-4,6-dinitro-2H-benzotriazole 1-oxide
2-(2,4-Dinitrophenyl)-6-nitro-2H-benzotriazole 1-oxide
4,6-Dinitro-2-o-tolyl-2H-benzotriazole 1-oxide
4,6-Dinitro-2-p-tolyl-2H-benzotriazole 1-oxide
4,6-Dinitro-2-(2,4,5-trimethylphenyl)-2H-benzotriazole 1-oxide
2-(4-Methoxyphenyl)-2H-benzotriazole 1-oxide
2-(4-Methoxyphenyl)-6-methyl-2H-benzotriazole 1-oxide
5-Methyl-6-nitro-2-m-tolyl-2H-benzotriazole 1-oxide
5-Methyl-6-nitro-2-o-tolyl-2H-benzotriazole 1-oxide
5-Methyl-6-nitro-2-p-tolyl-2H-benzotriazole 1-oxide
6-Methyl-4-nitro-2-p-tolyl-2H-benzotriazole 1-oxide
6-Methyl-2-phenyl-2H-benzotriazole 1-oxide
4-Methyl-2-m-tolyl-2H-benzotriazole 1-oxide
4-Methyl-2-o-tolyl-2H-benzotriazole 1-oxide
4-Methyl-2-p-tolyl-2H-benzotriazole 1-oxide
6-Methyl-2-m-tolyl-2H-benzotriazole 1-oxide
6-Methyl-2-o-tolyl-2H-benzotriazole 1-oxide
6-Methyl-2-p-tolyl-2H-benzotriazole 1-oxide
2-[1]Naphthyl-4,6-dinitro-2H-benzotriazole 1-oxide
2-[2]Naphthyl-4,6-dinitro-2H-benzotriazole 1-oxide
2-[1]Naphthyl-6-nitro-2H-benzotriazole 1-oxide
2-[2]Naphthyl-6-nitro-2H-benzotriazole 1-oxide
2-(3-Nitrophenyl)-2H-benzotriazole 1-oxide
6-Nitro-2-phenyl-2H-benzotriazole 1-oxide
4-Nitro-2-p-tolyl-2H-benzotriazole 1-oxide
6-Nitro-2-o-tolyl-2H-benzotriazole 1-oxide
6-Nitro-2-p-tolyl-2H-benzotriazole 1-oxide
6-Nitro-2-(2,4,5-trimethylphenyl)-2H-benzotriazole 1-oxide
2-Phenyl-2H-benzotriazole 1-oxide
2-o-Tolyl-2H-benzotriazole 1-oxide
2-p-Tolyl-2H-benzotriazole 1-oxide

The mediator may preferably be further selected from the group of cyclic N-hydroxy compounds having at least one optionally substituted five- or six-membered ring containing the structure identified in the general formula (V) 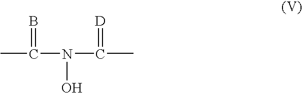
and also salts, ethers or esters thereof, where
B and D are the same or different and denote oxygen, sulfur or NR¹⁸, where
R¹⁸ represents hydrogen, hydroxyl, formyl, carbamoyl, sulfo, esters or salts thereof, sulfamoyl, nitro, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters or salts thereof, where the carbamoyl, sulfamoyl, amino and phenyl radicals may be unsubstituted or singly or multiply R¹⁹ substituted and the aryl-C₁-C₅-alkyl, C₁-C₁₂-alkyl, C₁-C₅-alkoxy, C₁-C₁₀-carbonyl and carbonyl-C₁-C₆-alkyl radicals may be saturated or unsaturated, branched or unbranched and may similarly be singly or multiply R¹⁹ substituted, where R¹⁹ in each occurrence is the same or different and denotes hydroxyl, formyl or carboxyl and also esters or salts thereof, carbamoyl or sulfo, esters or salts thereof, sulfamoyl, nitro, amino, phenyl, C₁-C₅-alkyl or C₁-C₅-alkoxy.

Preferably the mediator is selected from the group of compounds of the general formula (VI), (VII), (VIII) or (IX) 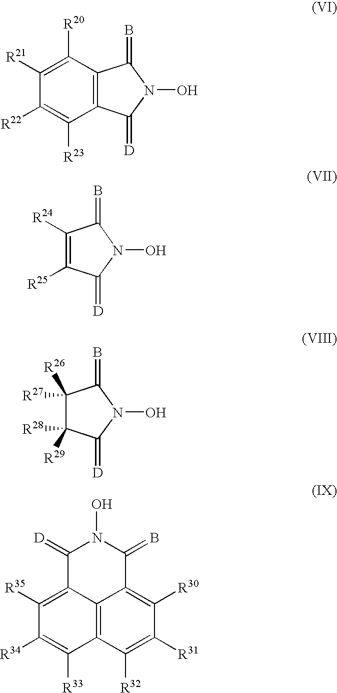
where B and D are each as defined above and the radicals R²⁰-R³⁵ are the same or different and have halogen, carboxyl, salts or esters of carboxyl or have the meanings defined for R¹⁸, although R²⁶ and R²⁷ on the one hand and R²⁸ and R²⁹ on the other must not both denote hydroxyl or amino and optionally any two of the substituents R²⁰-R²³, R²⁴-R²⁵, R²⁶-R²⁹, R³⁰-R³⁵ may be linked together to form a ring -E-, where -E- has one of the following meanings:
(—CH═CH)ₙ with n=1 to 3, —CH═CH—CH═N— or 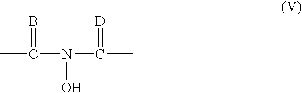
and where optionally the radicals R²⁶-R²⁹ may also be bonded together by one or two bridge elements —F—, where —F— in each occurrence is the same or different and has one of the following meanings: -0-, —S, —CH₂—, —CR³⁶═CR³⁷—, where R³⁶ and R³⁷ are the same or different and have the meaning of R²⁰.

Compounds which are particularly preferred for use as mediators have the general formulae (VI), (VII), (VIII) or (IX) wherein B and D denote oxygen or sulfur.

Examples of such compounds are N-hydroxyphthalimide and also optionally substituted N-hydroxyphthalimide derivatives, N-hydroxymaleimide and also optionally substituted N-hydroxymaleimide derivatives, N-hydroxynaphthalimide and also optionally substituted N-hydroxynaphthaleneimide derivatives, N-hydroxysuccinimide and optionally substituted N-hydroxysuccinimide derivatives, preferably those wherein the radicals R²⁶-R²⁹ are bonded together to form polycyclic structures.

Examples of compounds of the formula (VI) useful as a mediator are:
N-Hydroxyphthalimide
4-Amino-N-hydroxyphthalimide
3-Amino-N-hydroxyphthalimide
N-Hydroxy-benzene-1,2,4-tricarboximide
N,N′-Dihydroxy-pyromellitic diimide
N,N′-Dihydroxy-benzophenone-3,3′,4,4′-tetracarboxylic diimide.

Examples of compounds of the formula (VII) useful as a mediator are:
N-Hydroxymaleimide
Pyridine-2,3-dicarboxylic N-hydroxyimide.

Examples of compounds of the formula (VIII) useful as a mediator are:
N-Hydroxysuccinimide
N-Hydroxytartarimide
N-Hydroxy-5-norbornene-2,3-dicarboxylic imide
exo-N-Hydroxy-7-oxabicyclo[2.2.1]-hept-5-ene-2,3-dicarboximide
N-Hydroxy-cis-cyclohexane-1,2-dicarboximide
N-Hydroxy-cis-4-cyclohexene-1,2-dicarboximide.

An example of a compound of the formula (IX) useful as a mediator is:
N-Hydroxynaphthalimide sodium salt

An example of a useful mediator having a six-membered ring containing the structure identified in the formula (V) is:
N-Hydroxyglutarimide

The compounds identified by way of example are also useful as a mediator in the form of their salts or esters.

Compounds likewise useful as a mediator are selected from the group of N-aryl-N-hydroxyamides.

Of these it is preferably the compounds of the general formula (X), (XI) or (XII) which are used as mediators 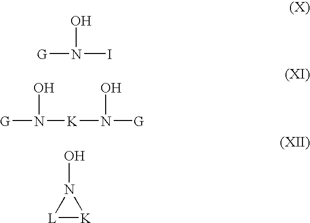
and also salts, ethers or esters thereof, where
G is a monovalent homo- or heteroaromatic mono- or binuclear radical and
L is a bivalent homo- or heteroaromatic mono- or binuclear radical and where these aromatic radicals may be substituted by one or more, identical or different R³⁸ radicals, where R³⁸ may represent halogen, hydroxyl, formyl, cyano, carbamoyl, carboxyl, esters or salts thereof, sulfo, esters or salts thereof, sulfamoyl, nitro, nitroso, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono, phosphonooxy, esters or salts thereof, where the carbamoyl, sulfamoyl, amino and phenyl radicals may in turn be unsubstituted or singly or multiply R³⁹ substituted and the aryl-C₁-C₅-alkyl C₁-C₁₂-alkyl, C₁-C₅-alkoxy, C₁-C₁₀-carbonyl, carbonyl-C₁-C₆-alkyl radicals may be saturated or unsaturated, branched or unbranched and may similarly be singly or multiply R³⁹ substituted, where R³⁹ in each occurrence is the same or different and denotes hydroxyl, formyl, cyano, carboxyl, esters or salts thereof, carbamoyl, sulfo, sulfamoyl, nitro, nitroso, amino, phenyl, C₁-C₅-alkyl, C₁-C₅-alkoxy, C₁-C₅-alkylcarbonyl and two R³⁸ or R³⁹ radicals at a time may be linked together pairwise via a [—CR⁴⁰R⁴¹—]ₘ bridge, where m is 0, 1, 2, 3 or 4, and R⁴⁰ and R⁴¹ are the same or different and denote carboxyl, esters or salts thereof, phenyl, C₁-C₅-alkyl, C₁-C₅-alkoxy or C₁-C₅-alkylcarbonyl and one or more nonadjacent [—CR⁴⁰R⁴¹—] groups may be replaced by O, S or an optionally C₁-C₅-alkyl-substituted imino radical and two adjacent [—CR⁴⁰R⁴¹—] groups by a [—CR⁴⁰═CR⁴¹] group and denotes a monovalent acid radical present in amidic form of acids selected from the group consisting of carboxylic acids having up to 20 carbon atoms, carbonic acid, half esters of carbonic acid or of carbamic acid, sulfonic acid, phosphonic acid, phosphoric acid, monoesters of phosphoric acid, and diesters of phosphoric acid and K is a divalent acid radical present in amidic form of acids selected from the group consisting of mono- and dicarboxylic acids having up to 20 carbon atoms, carbonic acid, sulfonic acid, phosphonic acid, phosphoric acid, monoesters of phosphoric acid.

Particularly preferred mediators include compounds of the general formula (XIII), (XIV), (XV), (XVI) or (XVII) 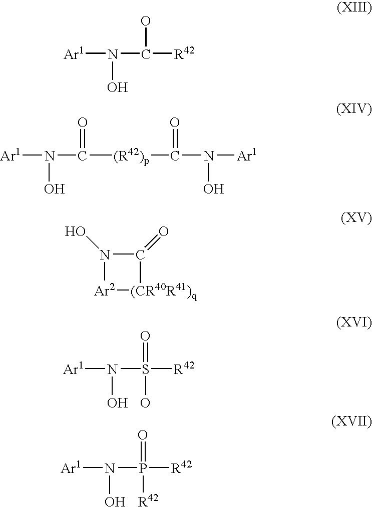
and also salts, ethers or esters thereof, where
Ar¹ denotes a univalent homo- or heteroaromatic mononuclear aryl radical and
Ar² denotes a bivalent homo- or heteroaromatic mononuclear aryl radical which may each be substituted by one or more, identical or different R⁴⁴ radicals, where R⁴⁴ represents hydroxyl, cyano, carboxyl, esters or salts thereof, sulfo, esters or salt thereof, nitro, nitroso, amino, C₁-C₁₂-alkyl, C₁-C₅-alkoxy, C₁-C₁₀-carbonyl, carbonyl or C₁-C₆-alkyl, where the amino radicals may be unsubstituted or singly or multiply R⁴⁵ substituted and the C₁-C₅-alkyl, C₁-C₅-alkoxy, C₁-C₁₀-carbonyl and carbonyl-C₁-C₆-alkyl radicals may be saturated or unsaturated, branched or unbranched and may similarly be singly or multiply R⁴⁵ substituted, where R⁴⁵ in each occurrence is the same or different and denotes hydroxyl, carboxyl, esters or salts thereof, sulfo, nitro, amino, C₁-C₅-alkyl, C₁-C₅-alkoxy or C₁-C₅-alkylcarbonyl and two R⁴⁴ radicals at a time may be linked together pairwise via a [—CR⁴⁰R⁴¹—]ₘ bridge where m is 0, 1, 2, 3 or 4, and
R⁴⁰ and R⁴¹ are each as defined above and one or more nonadjacent [—CR⁴⁰R⁴¹—] groups may be replaced by O, S or an optionally C₁-C₅-alkyl-substituted imino radical and two adjacent [—CR⁴⁰R⁴¹—] groups may be replaced by a [—CR⁴⁰═CR⁴¹—] group,
R⁴² in each occurrence is the same or different and denotes hydrogen, phenyl, aryl-C₁-C₅-alkyl, C₁-C₁₂-alkyl, C₁-C₅-alkoxy or C₁-C₁₀-carbonyl, where the phenyl radicals may be unsubstituted or singly or multiply R⁴⁶ substituted and the aryl-C₁-C₅-alkyl, C₁-C₁₂-alkyl, C₁-C₅-alkoxy, C₁-C₅-carbonyl radicals may be saturated or unsaturated, branched or unbranched and may similarly be singly or multiply R⁴⁶ substituted, where
R⁴⁶ in each occurrence is the same or different and denotes hydroxyl, formyl, cyano, carboxyl, esters or salts thereof, carbamoyl, sulfo, sulfamoyl, nitro, nitroso, amino, phenyl, C₁-C₅-alkyl or C₁-C₅-alkoxy and R⁴³ denotes divalent radicals ortho-, meta-, para-phenylene, aryl-C₁-C₆-alkyl, C₁-C₁₂-alkylene or C₁-C₅-alkylenedioxy, where the phenylene radicals may be unsubstituted or singly or multiply R⁴⁶ substituted and the aryl-C₁-C₅-alkyl, C₁-C₁₂-alkyl and C₁-C₅-alkoxy radicals may be saturated or unsaturated, branched or unbranched and may be singly or multiply R⁴⁶ substituted, where
p denotes 0 or 1 and
q denotes an integer from 1 to 3.

Preferably, Ar denotes a phenyl radical and Ar² denotes an ortho-phenylene radical, where Ar¹ may be substituted by up to five and, Ar² by up to four, identical or different radicals C₁-C₃-alkyl, C₁-C₃-alkylcarbonyl, carboxyl, esters or salts thereof, sulfo, esters or salts thereof, hydroxyl, cyano, nitro, nitroso or amino, where amino radicals may be substituted with two different radicals selected from the group consisting of hydroxyl and C₁-C₃-alkylcarbonyl.

Preferably R⁴² represents a univalent radical selected from the group consisting of hydrogen, phenyl, C₁-C₁₂-alkyl and C₁-C₅-alkoxy, where the C₁-C₁₂-alkyl and C₁-C₅-alkoxy may be saturated or unsaturated, branched or unbranched.

Preferably R⁴³ represents a bivalent radical: ortho- or para-phenylene, C₁-C₁₂-alkylene or C₁-C₅-alkylenedioxy, where the aryl-C₁-C₅-alkyl, C₁-C₁₂-alkyl and C₁-C₅-alkoxy radicals may be saturated or unsaturated, branched or unbranched and may be singly or multiply R⁴⁶ substituted.

Preferably R⁴⁶ denotes a carboxyl radical, esters or salts thereof, a carbamoyl, phenyl or C₁-C₃-alkoxy radical.

Examples of compounds useful as mediators are:
N-Hydroxyacetanilide,
N-Hydroxypivaloylanilide,
N-Hydroxyacryloylanilide,
N-Hydroxybenzoylanilide,
N-Hydroxy-methylsulfonylanilide,
Methyl N-hydroxy-N-phenylcarbamate,
N-Hydroxy-3-oxobutyrylanilide,
N-Hydroxy-4-cyanoacetanilide, N-hydroxy-4-methoxyacetanilide,
N-Hydroxyphenacetin,
N-Hydroxy-2,3-dimethylacetanilide,
N-Hydroxy-2-methylacetanilide,
N-Hydroxy-4-methylacetanilide,
1-Hydroxy-3,4-dihydroquinolin-(1H)-2-one,
N,N′-Dihydroxy-N,N′-diacetyl-1,3-phenylenediamine,
N,N′-Dihydroxy-succinic dianilide,
N,N′-Dihydroxy-maleic dianilide,
N,N′-Dihydroxy-oxalic dianilide,
N,N′-Dihydroxy-phosphoric dianilide,
N-Acetoxyacetanilide,
N-Hydroxymethyloxalylanilide,
N-Hydroxymaleic monoanilide.

Preferred for use as mediators are
N-Hydroxyacetanilide,
N-Hydroxyformanilide,
Methyl N-hydroxy-N-phenylcarbamate,
N-Hydroxy-2-methylacetanilide,
N-Hydroxy-4-methylacetanilide,
1-Hydroxy-3,4-dihydroquinolin-(1H)-2-one and also
N-Acetoxyacetanilide.

The mediator may further be selected from the group of N-alkyl-N-hydroxyamides.

Preference for use as mediators in this context is given to compounds of the general formula (XVIII) or (XIX) 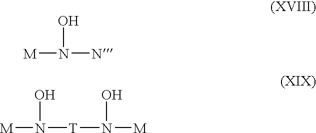
and also salts, ethers or esters thereof, where
M in each occurrence is the same or different and denotes a univalent linear or branched, cyclic or polycyclic, saturated or unsaturated C₁-C₂₄-alkyl radical and where this alkyl radical may be substituted by one or more R⁴⁸ radicals, where R⁴⁸ in each occurrence is the same or different and denotes hydroxyl, mercapto, formyl, carbamoyl, carboxyl, esters or salts thereof, sulfo, esters or salts thereof, sulfamoyl, nitro, nitroso, amino, hydroxylamino, phenyl, C₁-C₅-alkoxy, C₁-C₁₀-carbonyl, phospho, phosphono or phosphonooxy and also esters or salts thereof and where the carbamoyl, sulfamoyl, amino, hydroxylamino, mercapto and phenyl radicals may be unsubstituted or singly or multiply R⁴⁸ substituted and the C₁-C₅-alkoxy and C₁-C₁₀-carbonyl radicals may be saturated or unsaturated, branched or unbranched and may be singly or multiply R⁴⁸ substituted, where R⁴⁸ in each occurrence is the same or different and denotes hydroxyl, formyl, cyano, carboxyl, esters or salts thereof, carbamoyl, sulfo, sulfamoyl, nitro, nitroso, amino, phenyl, benzoyl, C₁-C₅-alkyl, C₁-C₅-alkoxy or C₁-C₅-alkylcarbonyl and non-α-disposed methylene groups may be replaced by oxygen or sulfur or an optionally monosubstituted imino radical, and
N′″ denotes a monovalent acid radical in amidic form of acids which are aliphatic, mono- or binuclear aromatic or mono- or binuclear heteroaromatic carboxylic acids having 1-20 carbon atoms, carbonic acid, half esters of carbonic acid or of carbamic acid, sulfonic acid, phosphonic acid, phosphoric acid, monoesters of phosphoric acid or diesters of phosphoric acid, and
T denotes a bivalent acid radical in amidic form of acids which are aliphatic, mono- or binuclear aromatic or mono- or binuclear heteroaromatic dicarboxylic acids having 1-20 carbon atoms, carbonic acid, sulfonic acid, phosphonic acid, phosphoric acid or monoesters of phosphoric acid, and where alkyl radicals of the aliphatic acids N′″ and T which are present in amidic form may be linear or branched, cyclic and/or polycyclic, saturated or unsaturated and contain 1-24 carbon atoms and are unsubstituted or singly or multiply R⁴⁷ substituted and where, furthermore, aryl and heteroaryl radicals of the aromatic or heteroaromatic acids N′″ and T which are present in amidic form may be substituted by one or more R⁴⁹ radicals, where R⁴⁹ in each occurrence is the same or different and denotes hydroxyl, mercapto, formyl, cyano, carbamoyl, carboxyl, esters or salts thereof, sulfo, esters or salts thereof, sulfamoyl, nitro, nitroso, amino, phenyl, aryl-C₁-C₅-alkyl, C₁-C₁₂-alkyl, C₁-C₅-alkoxy, C₁-C₁₀-carbonyl, phospho, phosphono or phosphonooxy and also esters or salts thereof and where carbamoyl, sulfamoyl, amino, mercapto and phenyl radicals may be unsubstituted or singly or multiply R⁴⁸ substituted and the aryl-C₁-C₅-alkyl, C₁-C₁₂-alkyl-C₁-C₅-alkoxy, C₁-C₁₀-carbonyl radicals may be saturated or unsaturated, branched or unbranched and may be singly or multiply R⁴⁸ substituted.

Particular preference for use as mediators is given to compounds having the general formulae (XX), (XXI), (XXII) or (XXIII): 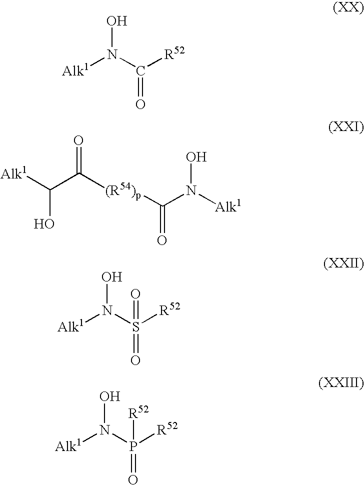
and also salts, ethers or esters thereof, where
Alk′ in each occurrence is the same or different and denotes a univalent linear or branched, cyclic or polycyclic, saturated or unsaturated C₁-C₁₀-alkyl radical,
where this alkyl radical may be substituted by one or more R⁵⁰ radicals, where R⁵⁰ in each occurrence is the same or different and denotes hydroxyl, formyl, carbamoyl, carboxyl, esters or salts thereof, sulfo, esters or salts thereof, sulfamoyl, nitro, nitroso, amino, hydroxylamino, phenyl, C₁-C₅-alkoxy or C₁-C₅-carbonyl and where the carbamoyl, sulfamoyl, amino, hydroxylamino and phenyl radicals may be unsubstituted or singly or multiply R⁵¹ substituted and the C₁-C₅-alkoxy and C₁-C₁₀-carbonyl radicals may be saturated or unsaturated, branched or unbranched and may be singly or multiply R⁵¹ substituted, where
R⁵¹ in each occurrence is the same or different and denotes hydroxyl, formyl, cyano, carboxyl, esters or salts thereof, carbamoyl, sulfo, sulfamoyl, nitro, amino, phenyl, benzoyl, C₁-C₅-alkyl, C₁-C₅-alkoxy or C₁-C₅-alkylcarbonyl and non-α-disposed methylene groups may be replaced by oxygen or sulfur or an optionally monosubstituted imino radical, and where
R⁵² denotes identical or different univalent radicals hydrogen, phenyl, pyridyl, furyl, pyrrolyl, thienyl, aryl C₁-C₅-alkyl, C₁-C₁₂-alkyl, C₁-C₁₀-alkoxy or C₁-C₁₀-carbonyl, where the phenyl, pyridyl, furyl, pyrrolyl and thienyl radicals may be unsubstituted or singly or multiply R⁵³ substituted and the aryl-C₁-C₅-alkyl, C₁-C₁₂-alkyl, C₁-C₅-alkoxy and C₁-C₁₀-carbonyl radicals may be saturated or unsaturated, branched or unbranched and may similarly be singly or multiply R⁵³ substituted, where
R⁵³ in each occurrence is the same or different and denotes hydroxyl, formyl, carboxyl, esters or salts thereof, carbamoyl, sulfo, sulfamoyl, nitro, amino, phenyl, C₁-C₅-alkyl or C₁-C₅-alkoxy, and
R⁵⁴ denotes bivalent radicals phenylene, pyridylene, thienylene, furylene, pyrrolylene, aryl-C₁-C₅-alkyl, C₁-C₁₂-alkylene, C₁-C₅-alkylenedioxy, where phenylene, pyridylene, thienylene, furylene or pyrrolylene may be unsubstituted or singly or multiply R⁵³ substituted and the aryl-C₁-C₅-alkyl, C₁-C₁₂-alkyl, C₁-C₅-alkoxy radicals may be saturated or unsaturated, branched or unbranched and may similarly be singly or multiply R⁵³ substituted, where p denotes 0 or 1.

Very particular preference for use as mediators is given to compounds having the general formula (XX), (XXI), (XXII) and (XXIII) wherein

Alk¹ in each occurrence is the same or different and denotes a univalent, linear, branched or cyclic, saturated or unsaturated C₁-C₁₀-alkyl radical, where this alkyl radical may be substituted by one or more R⁵⁰ radicals, where R⁵⁰ in each occurrence is the same or different and denotes hydroxyl, carbamoyl, carboxyl, esters or salts thereof, sulfo, esters or salts thereof, sulfamoyl, amino, phenyl, C₁-C₅-alkoxy or C₁-C₅-carbonyl and where the carbamoyl, sulfamoyl, amino and phenyl radicals may be unsubstituted or singly or multiply R⁵¹ substituted and the C₁-C₅-alkoxy and C₁-C₁₀-carbonyl radicals may be saturated or unsaturated, branched or unbranched and may similarly be singly or multiply R⁵¹ substituted, where R⁵¹ in each occurrence is the same or different and denotes hydroxyl, carboxyl, esters or salts thereof, carbamoyl, sulfo, sulfamoyl, nitro, amino, phenyl, benzoyl, C₁-C₅-alkyl, C₁-C₅-alkoxy or C₁-C₅-alkylcarbonyl and where R⁵² denotes identical or different univalent radicals hydrogen, phenyl, furyl, aryl-C₁-C₅-alkyl, C₁-C₁₂-alkyl, C₁-C₁₀-alkoxy or C₁-C₁₀-carbonyl, where the phenyl and furyl radicals may be unsubstituted or singly or multiply R⁵³ substituted and the aryl-C₁-C₅-alkyl, C₁-C₁₂-alkyl, C₁-C₅-alkoxy and C₁-C₁₀-carbonyl radicals may be saturated or unsaturated, branched or unbranched and may be singly or multiply R⁵³ substituted, where

R⁵³ in each occurrence is the same or different and denotes carboxyl, esters or salts thereof, carbamoyl, phenyl, C₁-C₅-alkyl or C₁-C₅-alkoxy, and

R⁵⁴ denotes a bivalent radical phenylene, furylene, C₁-C₁₂-alkylene and C₁-C₅-alkylenedioxy, where phenylene and furylene may be unsubstituted or singly or multiply R⁵³ substituted and the aryl-C₁-C₅-alkyl, C₁-C₁₂-alkyl, C₁-C₅-alkoxy radicals may be saturated or unsaturated, branched or unbranched and may be singly or multiply R⁵³ substituted,

where p denotes 0 or 1.

Examples of compounds useful as mediators are
N-Hydroxy-N-methyl-benzamide,
N-Hydroxy-N-methyl-benzenesulfonamide,
N-Hydroxy-N-methyl-p-toluenesulfonamide,
N-Hydroxy-N-methyl-furan-2-carboxamide,
N-Hydroxy-N-methyl-thiophene-2-carboxamide,
N,N′-Dihydroxy-N,N′-dimethyl-phthalamide,
N,N′-Dihydroxy-N,N′-dimethyl-isophthalamide,
N,N′-Dihydroxy-N,N′-dimethyl-terephthalamide,
N,N′-Dihydroxy-N,N′-dimethyl-benzene-1,3-disulfonamide,
N,N′-Dihydroxy-N,N′-dimethyl-furan-3,4-dicarboxamide,
N-Hydroxy-N-tert-butyl-benzamide,
N-Hydroxy-N-tert-butyl-benzenesulfonamide,
N-Hydroxy-N-tert-butyl-p-toluenesulfonamide,
N-Hydroxy-N-tert-butyl-furan-2-carboxamide,
N-Hydroxy-N-tert-butyl-thiophene-2-carboxamide,
N,N′-Dihydroxy-N,N′-di-tert-butyl-phthalamide,
N,N′-Dihydroxy-N,N′-di-tert-butyl-isophthalamide,
N,N′-Dihydroxy-N,N′-di-tert-butylterephthalamide,
N,N′-Dihydroxy-N,N′-di-tert-butyl-benzene-1,3-disulfonamide,
N,N′-Dihydroxy-N,N′-di-tert-butyl-furan-3,4-dicarboxamide,
N-Hydroxy-N-cyclohexyl-benzamide,
N-Hydroxy-N-cyclohexylbenzenesulfonamide,
N-Hydroxy-N-cyclohexyl-p-toluenesulfonamide,
N-Hydroxy-N-cyclohexyl-furan-2-carboxamide,
N-Hydroxy-N-cyclohexyl-thiophene-2-carboxamide,
N,N′-Dihydroxy-N,N′-dicyclohexyl-phthalamide,
N,N′-Dihydroxy-N,N′-dicyclohexyl-isophthalamide,
N,N′-Dihydroxy-N,N′-dicyclohexyl-terephthalamide,
N,N′-Dihydroxy-N,N′-dicyclohexyl-benzene-1,3-disulfonamide,
N,N′-Dihydroxy-N,N′-dicyclohexyl-furan-3,4-dicarboxamide,
N-Hydroxy-N-isopropyl-benzamide,
N-Hydroxy-N-isopropylbenzene-sulfonamide,
N-Hydroxy-N-isopropyl-p-toluenesulfonamide,
N-Hydroxy-N-isopropyl-furan-2-carboxamide,
N-Hydroxy-N-isopropyl-thiophene-2-carboxamide,
N,N′-Dihydroxy-N,N′-diisopropyl-phthalamide,
N,N′-Dihydroxy-N,N′-diisopropyl-isophthalamide,
N,N′-Dihydroxy-N,N′-diisopropyl-terephthalamide,
N,N′-Dihydroxy-N,N′-diisopropyl-benzene-1,3-disulfonamide,
N,N′-Dihydroxy-N,N′-diisopropyl-furan-3,4-dicarboxamide,
N-Hydroxy-N-methyl-acetamide,
N-Hydroxy-N-tert-butyl-acetamide,
N-Hydroxy-N-isopropyl-acetamide,
N-Hydroxy-N-cyclohexyl-acetamide,
N-Hydroxy-N-methyl-pivalamide,
N-Hydroxy-N-isopropyl-pivalamide,
N-Hydroxy-N-methyl-acrylamide,
N-Hydroxy-N-tert-butyl-acryl amide,
N-Hydroxy-N-isopropyl-acrylamide,
N-Hydroxy-N-cyclohexyl-acrylamide,
N-Hydroxy-N-methyl-methanesulfonamide,
N-Hydroxy-N-isopropylmethanesulfonamide,
Methyl N-hydroxy-N-isopropylcarbamate,
N-Hydroxy-N-methyl-3-oxo-butyramide,
N,N′-Dihydroxy-N,N′-dibenzoyl-ethylenediamine,
N,N′-Dihydroxy-N,N′-dimethylsuccinamide,
N,N′-Dihydroxy-N,N′-di-tert-butyl-maleiimide,
N-Hydroxy-N-tert-butyl-maleic monoamide,
N,N′-Dihydroxy-N,N′-di-tert-butyl-oxalamide,
N,N′-Dihydroxy-N,N′-di-tert-butyl-phosphoramide.

Preference for use as mediators is given to compounds selected from the group consisting of
N-Hydroxy-N-methyl-benzamide,
N-Hydroxy-N-methylbenzenesulfonamide,
N-Hydroxy-N-methyl-p-toluenesulfonamide,
N-Hydroxy-N-methylfuran-2-carboxamide,
N,N′-Dihydroxy-N,N′-dimethyl-phthalamide,
N,N′-Dihydroxy-N,N′-dimethyl-terephthalamide,
N,N′-Dihydroxy-N,N′-dimethyl-benzene-1,3-disulfonamide,
N-Hydroxy-N-tert-butyl-benzamide,
N-Hydroxy-N-tert-butyl-benzenesulfonamide,
N-Hydroxy-N-tert-butyl-p-toluenesulfonamide,
N-Hydroxy-N-tert-butyl-furan-2-carboxamide,
N,N′-Dihydroxy-N,N′-di-tert-butyl-terephthalamide,
N-Hydroxy-N-isopropyl-benzamide,
N-Hydroxy-N-isopropyl-p-toluenesulfonamide,
N-Hydroxy-N-isopropyl-furan-2-carboxamide,
N,N′-Dihydroxy-N,N′-diisopropyl-terephthalamide,
N,N′-Dihydroxy-N,N′-diisopropyl-benzene-1,3-disulfonamide,
N-Hydroxy-N-methyl-acetamide,
N-Hydroxy-N-tert-butyl-acetamide,
N-Hydroxy-N-isopropylacetamide,
N-Hydroxy-N-cyclohexyl-acetamide,
N-Hydroxy-N-methyl-pivalamide,
N-Hydroxy-N-tert-butyl-acrylamide,
N-Hydroxy-N-isopropyl-acrylamide,
N-Hydroxy-N-methyl-3-oxo-butyramide,
N,N′-Dihydroxy-N,N′-dibenzoyl-ethylenediamine,
N,N′-Dihydroxy-N,N′-di-tert-butyl-maleiimide,
N-Hydroxy-N-tert-butyl-maleic monoamide,
N,N′-Dihydroxy-N,N′-di-tert-butyl-oxalamide.

The mediator may further be selected from the group of oximes of the general formula (XXIV) or (XXV) 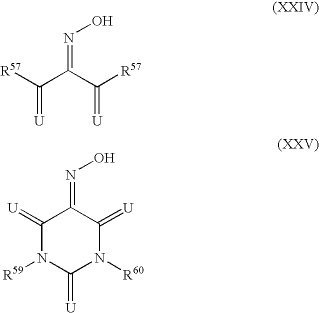
and also salts, ethers or esters thereof, where
U in each occurrence is the same or different and denotes oxygen, sulfur or N⁵⁵, where
R⁵⁵ denotes hydrogen, hydroxyl, formyl, carbamoyl, sulfo, esters or salts thereof, sulfamoyl, nitro, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters or salts thereof,
where the carbamoyl, sulfamoyl, amino and phenyl radicals may be unsubstituted or singly or multiply R⁵⁶ substituted and the aryl-C₁-C₅-alkyl, C₁-C₁₀-alkyl, C₁-C₅-alkoxy, C₁-C₁₀-carbonyl and carbonyl-C₁-C₆-alkyl radicals may be saturated or unsaturated, branched or unbranched and may be singly or multiply R⁵⁶ substituted, where
R⁵⁶ in each occurrence is the same or different and denotes hydroxyl, formyl, carboxyl, esters or salts thereof, carbamoyl, sulfo, esters or salts thereof, sulfamoyl, nitro, amino, phenyl, C₁-C₅-alkyl or C₁-C₅-alkoxy, and
the radicals R⁵⁷ and R⁵⁸ are the same or different and denote halogen or carboxyl and also esters or salts thereof, or have the meanings defined for R⁵⁵, or are linked together to form a [—CR⁶¹R⁶²], ring, where n is 2, 3 or 4, and
R⁵⁹ and R⁶⁰ have the meanings defined for R⁵⁵, and
R⁶¹ and R⁶² are the same or different and denote halogen or carboxyl and also esters or salts thereof, or have the meanings defined for R⁵⁵.

Particular preference for use as mediators is given to compounds having the general formula (XXIV) wherein U denotes oxygen or sulfur and the remaining radicals are each as defined above. Dimethyl 2-hydroxyiminomalonate is an example of such a compound.

Particular preference for use as mediators is further given to isonitroso derivatives of cyclic ureides of the general formula (XXV). Examples of such compounds are
1-methylvioluric acid, 1,3-dimethylvioluric acid, thiovioluric acid, alloxane-4,5-dioxime.

Especial preference for use as a mediator is given to alloxane-5-oxime hydrate (violuric acid) and/or its esters, ethers or salts.

The mediator may further be selected from the group of vicinally nitroso-substituted aromatic alcohols of the general formulae (XXVI) or (XXVII) 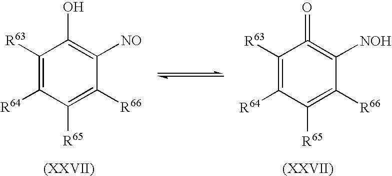
and also salts, ethers or esters thereof, where
R⁶³, R⁶⁴, R⁶⁵ and R⁶⁶ are the same or different and denote hydrogen, halogen, hydroxyl, formyl, carbamoyl or carboxyl and also esters or salts thereof, sulfo, esters or salts thereof, sulfamoyl, nitro, nitroso, cyano, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters or salts thereof, where the carbamoyl, sulfamoyl, amino and phenyl radicals may be unsubstituted or singly or multiply R⁶⁷ substituted and the aryl-C₁-C₅-alkyl, C₁-C₁₂-alkyl, C₁-C₅-alkoxy, C₁-C₁₀-carbonyl, carbonyl-C₁-C₆-alkyl radicals may be saturated or unsaturated, branched or unbranched and may be singly or multiply R⁶⁷ substituted, where
R⁶⁷ in each occurrence is the same or different and denotes hydroxyl, formyl or carboxyl and also esters or salts thereof, carbamoyl, sulfo and also salts or esters thereof, sulfamoyl, nitro, nitroso, amino, phenyl, C₁-C₅-alkyl or C₁-C₅-alkoxy or the R⁶³, R⁶⁴, R⁶⁵ and R⁶⁶ radicals are linked together pairwise to form a [—CR⁶⁸R⁶⁹—]ₘ ring, where m is an integer from 1 to 4, or to form a [—CR⁷⁰═CR⁷¹—]ₙ ring, where n is an integer from 1 to 3, and
R⁶⁸, R⁶⁹, R⁷⁰ and R⁷¹ are the same or different and have the meanings defined for R⁶³ to R⁶⁶.

Aromatic alcohols are preferably to be understood as meaning phenols or fused derivatives of phenol.

Preference for use as mediators is given to compounds of the general formula (XXVI) or (XXVII) whose synthesis can be reduced to the nitrosation of substituted phenols.

Examples of such compounds are:
2-Nitrosophenol,
3-Methyl-6-nitrosophenol,
2-Methyl-6-nitrosophenol,
4-Methyl-6-nitrosophenol,
3-Ethyl-6-nitrosophenol,
2-Ethyl-6-nitrosophenol,
4-Ethyl-6-nitrosophenol,
4-Isopropyl-6-nitrosophenol,
4-tert-butyl-6-nitrosophenol,
2-Phenyl-6-nitrosophenol,
2-Benzyl-6-nitrosophenol,
4-Benzyl-6-nitrosophenol,
2-Hydroxy-3-nitrosobenzyl alcohol,
2-Hydroxy-3-nitrosobenzoic acid,
4-Hydroxy-3-nitrosobenzoic acid,
2-Methoxy-6-nitrosophenol,
3,4-Dimethyl-6-nitrosophenol,
2,4-Dimethyl-6-nitrosophenol,
3,5-Dimethyl-6-nitrosophenol,
2,5-Dimethyl-6-nitrosophenol,
2-Nitrosoresorcinol,
4-Nitrosoresorcinol,
2-Nitrosoorcinol,
2-Nitrosophloroglucine,
4-Nitrosopyrogallol,
4-Nitroso-3-hydroxyaniline,
4-Nitro-2-nitrosophenol.

Preference for use as mediators is further given to o-nitroso derivatives of fused aromatic alcohols.

Examples of such compounds are:
2-Nitroso-1-naphthol,
1-Methyl-3-nitroso-2-naphthol,
9-Hydroxy-10-nitroso-phenanthrene.

Particular preference for use as mediators is given to:
1-Nitroso-2-naphthol,
1-Nitroso-2-naphthol-3,6-disulfonic acid,
2-Nitroso-1-naphthol-4-sulfonic acid,
2,4-Dinitroso-1,3-dihydroxybenzene
   and also esters, ethers or salts thereof.

The mediator may further be selected from the group consisting of hydroxypyridines, aminopyridines, hydroxyquinolines, aminoquinolines, hydroxyisoquinolines, aminoisoquinolines, having nitroso or mercapto substituents ortho or para to the hydroxyl or amino groups, tautomers of the identified compounds and also their salts, ethers and esters.

Preference for use as mediators is given to compounds of the general formula (XXVIII), (XXIX) or (XXX) 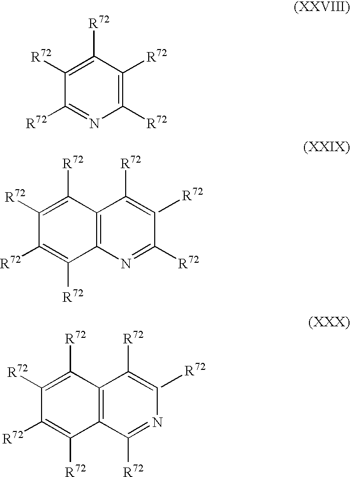
and also tautomers, salts, ethers or esters thereof, where in the formulae (XXVIII), (XXIX) and (XXX) two mutually ortho- or para-disposed R⁷² radicals denote hydroxyl and nitroso or hydroxyl and mercapto or nitroso and amino and the other R⁷² radicals are the same or different and denote hydrogen, halogen, hydroxyl, mercapto, formyl, cyano, carbamoyl or carboxyl and also esters and salts thereof, sulfo, esters and salts thereof, sulfamoyl, nitro, nitroso, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters and salts thereof and where the carbamoyl, sulfamoyl, amino, mercapto and phenyl radicals may be unsubstituted or singly or multiply R⁷³ substituted and the aryl-C₁-C₅-alkyl, C₁-C₁₂-alkyl, C₁-C₅-alkoxy, C₁-C₁₀-carbonyl, carbonyl-C₁-C₆-alkyl radicals may be saturated or unsaturated, branched or unbranched and may be singly or multiply R⁷³ substituted, where R⁷³ in each occurrence is the same or different and denotes hydroxyl, formyl, cyano or carboxyl and also esters or salts thereof, carbamoyl, sulfo, sulfamoyl, nitro, nitroso, amino, phenyl, C₁-C₅-alkyl, C₁-C₅-alkoxy or C₁-C₅-alkylcarbonyl and two R⁷² radicals at a time or two R⁷³ radicals at a time or R⁷² and R⁷³ may be linked together pairwise via a [—CR⁷⁴R⁷⁵—]ₘ bridge, where m is 1, 2, 3 or 4, and R⁷⁴ and R⁷⁵ are the same or different and denote carboxyl, esters or salts thereof, phenyl, C₁-C₅-alkyl, C₁-C₅-alkoxy or C₁-C₅-alkylcarbonyl and one or more nonadjacent [—CR⁷⁴R⁷⁵—] groups may be replaced by oxygen or sulfur or an optionally C₁-C₅-alkyl-substituted imino radical and two adjacent [—CR⁷⁴R⁷⁵—] groups may be replaced by one [—CR⁷⁴═R⁷⁵—] group.

Particular preference for use as mediators is given to compounds of the general formula (XXVIII) or (XXIX) and also their tautomers, salts, ethers or esters, where in the formulae (XXVIII) and (XXIX) two mutually ortho-disposed R⁷² radicals particularly preferably denote hydroxyl and nitroso or hydroxyl and mercapto or nitroso and amino and the other R⁷² radicals are the same or different and denote hydrogen, hydroxyl, mercapto, formyl, carbamoyl or carboxyl and also esters and salts thereof, sulfo, esters and salts thereof, sulfamoyl, nitro, nitroso, amino, phenyl, aryl-C₁-C₅-alkyl, C₁-C₅-alkyl, C₁-C₅-alkoxy, C₁-C₅-carbonyl, carbonyl-C₁-C₆-alkyl, phospho, phosphono or phosphonooxy and also esters and salts thereof, where the carbamoyl, sulfamoyl, amino, mercapto and phenyl radicals may be unsubstituted or singly or multiply R⁷³ substituted and the aryl-C₁-C₅-alkyl, C₁-C₅-alkyl, C₁-C₅-alkoxy, C₁-C₅-carbonyl, carbonyl-C₁-C₆-alkyl radicals may be saturated or unsaturated, branched or unbranched and may be singly or multiply R⁷³ substituted, where R⁷³ is as defined above and two R⁷³ radicals at a time may be linked together pairwise via a [—CR⁷⁴R⁷⁵—]ₘ bridge, where m is 2, 3 or 4, and R⁷⁴ and R⁷⁵ are as defined above and one or more nonadjacent [—CR⁷⁴R⁷⁵—] groups may be replaced by O or an optionally C₁-C₅-alkyl-substituted imino radical.

Examples of compounds useful as mediators are
2,6-Dihydroxy-3-nitrosopyridine,
2,3-Dihydroxy-4-nitrosopyridine,
2,6-Dihydroxy-3-nitrosopyridine-4-carboxylic acid,
2,4-Dihydroxy-3-nitrosopyridine,
3-Hydroxy-2-mercaptopyridine,
2-Hydroxy-3-mercaptopyridine,
2,6-Diamino-3-nitrosopyridine,
2,6-Diamino-3-nitroso-pyridine-4-carboxylic acid,
2-Hydroxy-3-nitrosopyridine,
3-Hydroxy-2-nitrosopyridine,
2-Mercapto-3-nitrosopyridine,
3-Mercapto-2-nitrosopyridine,
2-Amino-3-nitrosopyridine,
3-Amino-2-nitrosopyridine,
2,4-Dihydroxy-3-nitrosoquinoline,
8-Hydroxy-5-nitroisoquinoline,
2,3-Dihydroxy-4-nitrosoquinoline,
3-Hydroxy-4-nitrosoisoquinoline,
4-Hydroxy-3-nitrosoisoquinoline,
8-Hydroxy-5-nitrosoisoquinoline and also tautomers of these compounds.

Preference for use as mediators is given to
2,6-Dihydroxy-3-nitrosopyridine,
2,6-Diamino-3-nitrosopyridine,
2,6-Dihydroxy-3-nitrosopyridine-4-carboxylic acid,
2,4-Dihydroxy-3-nitrosopyridine,
2-Hydroxy-3-mercaptopyridine,
2-Mercapto-3-pyridinol,
2,4-Dihydroxy-3-nitrosoquinoline,
8-Hydroxy-5-nitrosoquinoline,
2,3-Dihydroxy-4-nitrosoquinoline
   and also tautomers of these compounds.

The mediator may further be selected from the group of stable nitroxyl free radicals (nitroxides), i.e., these free radicals can be obtained, characterized and stored in pure form.

Preference for use as mediators is given in this connection to compounds of the general formula (XXXI), (XXXII) or (XXXIII) 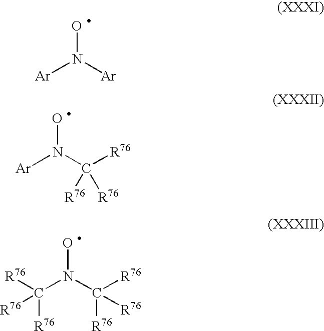
where
Ar is a univalent homo- or heteroaromatic mono- or binuclear radical and where this aromatic radical may be substituted by one or more, identical or different R⁷⁷ radicals, where R⁷⁷ denotes halogen, formyl, cyano, carbamoyl, carboxyl, esters or salts thereof, sulfo, esters or salt thereof, sulfamoyl, nitro, nitroso, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters or salts thereof, and
where the phenyl, carbamoyl and sulfamoyl radicals may be unsubstituted or singly or multiply R⁷⁸ substituted, the amino radical may be singly or doubly R⁷⁸ substituted and the aryl-C₁-C₅-alkyl, C₁-C₁₂-alkyl, C₁-C₅-alkoxy, C₁-C₁₀-carbonyl, carbonyl-C₁-C₆-alkyl radicals may be saturated or unsaturated, branched or unbranched and may be singly or multiply R⁷⁸ substituted,
where R⁷⁸ may occur one or more times and in each occurrence is the same or different and denotes hydroxyl, formyl, cyano, carboxyl and also esters or salts thereof, carbamoyl, sulfo, sulfamoyl, nitro, nitroso, amino, phenyl, C₁-C₅-alkyl, C₁-C₅-alkoxy or C₁-C₅-alkylcarbonyl, and
R⁷⁶ in each occurrence is the same or different and denotes halogen, hydroxyl, mercapto, formyl, cyano, carbamoyl, carboxyl and also esters or salts thereof, sulfo, esters or salts thereof, sulfamoyl, nitro, nitroso, amino, phenyl, aryl-C₁-C₅-alkyl, C₁-C₁₂-alkyl, C₁-C₅-alkoxy, C₁-10-carbonyl, carbonyl-C₁-C₆-alkyl, phospho, phosphono or phosphonooxy and also esters or salts thereof, and
R⁷⁶ may also denote hydrogen in the case of bicyclic stable nitroxyl free radicals (structure XXXIII), and
where the carbamoyl, sulfamoyl, amino, mercapto and phenyl radicals may be unsubstituted or singly or multiply R⁷⁹ substituted and the aryl-C₁-C₅-alkyl, C₁-C₁₂-alkyl, C₁-C₅-alkoxy, C₁-C₁₀-carbonyl, carbonyl-C₁-C₆-alkyl radicals may be saturated or unsaturated, branched or unbranched and may be singly or multiply R⁷⁹ substituted, where R⁷⁹ in each occurrence is the same or different and denotes hydroxyl, formyl, cyano, carboxyl, esters or salts thereof, carbamoyl, sulfo, esters and salts thereof, sulfamoyl, nitro, nitroso, amino, phenyl, C₁-C₅-alkyl, C₁-C₅-alkoxy or C₁-C₅-alkylcarbonyl and two R⁷⁸ or R⁷⁹ radicals at a time may be linked together pairwise via a [—CR⁸⁰R⁸¹—]ₘ bridge, where m is 0, 1, 2, 3 or 4, and
R⁸⁰ and R⁸¹ are the same or different and denote halogen, carboxyl and also esters or salts thereof, carbamoyl, sulfamoyl, phenyl, benzoyl, C₁-C₅-alkyl, C₁-C₅-alkoxy or C₁-C₅-alkylcarbonyl and one or more nonadjacent [—CR⁸⁰R⁸¹—] groups may be replaced by oxygen or sulfur or an optionally C₁-C₅-alkyl-substituted imino radical and two adjacent [—CR⁸⁰R⁸¹—] groups may be replaced by one [—CR⁸⁰═CR⁸¹—], [—CR⁸⁰═N—] or [—CR⁸⁰═N(O)—] group.

Particular preference for use as mediators is given to nitroxyl free radicals of the general formulae (XXXIV) and (XXXV) 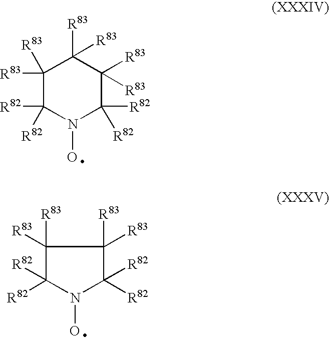
where
R⁸² in each occurrence is the same or different and denotes phenyl, aryl-C₁-C₅-alkyl, C₁-C₁₂-alkyl, C₁-C₅-alkoxy, C₁-C₁₀-carbonyl or carbonyl-C₁-C₆-alkyl, where the phenyl radicals may be unsubstituted or singly or multiply R⁸⁴ substituted and the aryl-C₁-C₅-alkyl, C₁-C₁₂-alkyl, C₁-C₅-alkoxy, C₁-C₁₀-carbonyl and carbonyl-C₁-C₆-alkyl radicals may be saturated or unsaturated, branched or unbranched and may be singly or multiply R⁸⁴ substituted, where R⁸⁴ may occur one or more times and in each occurrence is the same or different and denotes hydroxyl, formyl or carboxyl and also esters or salts thereof, carbamoyl, sulfo, esters and salts thereof, sulfamoyl, nitro, nitroso, amino, phenyl, benzoyl, C₁-C₅-alkyl, C₁-C₅-alkoxy or C₁-C₅-alkylcarbonyl, and
R⁸³ in each occurrence is the same or different and denotes hydrogen, hydroxyl, mercapto, formyl, cyano, carbamoyl, carboxyl and also esters or salts thereof, sulfo and also esters or salts thereof, sulfamoyl, nitro, nitroso, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters or salts thereof, where the carbamoyl, sulfamoyl, amino, mercapto and phenyl radicals may be unsubstituted or singly or multiply R⁷⁸ substituted and the aryl-C₁-C₅-alkyl, C₁-C₁₂-alkyl, C₁-C₅-alkoxy, C₁-C₁₀-carbonyl and carbonyl-C₁-C₆-alkyl radicals may be saturated or unsaturated, branched or unbranched and may be singly or multiply R⁷⁸ substituted and one [—CR⁸³R⁸³—] group may be replaced by oxygen, an optionally C₁-C₅-alkyl-substituted imino radical, a (hydroxy)imino radical, a carbonyl function or an optionally R⁷⁸ mono- or disubstituted vinylidene function and two adjacent [—CR⁸³R⁸³—] groups may be replaced by one [—CR⁸³—CR⁸³—] or [—CR⁸³═N—] or [—CR⁸³═N(O)—] group.

Examples of compounds useful as mediators are
2,2,6,6-Tetramethyl-1-piperidinyloxy free radical (TEMPO),
4-Hydroxy-2,2,6,6-tetramethyl-1-piperidinyloxy free radical,
4-Oxo-2,2,6,6-tetramethyl-1-piperidinyloxy free radical,
4-Acetamido-2,2,6,6-tetramethyl-1-piperidinyloxy free radical,
4-(Ethoxyfluorophosphinyloxy)-2,2,6,6-tetramethyl-1-piperidinyloxy free radical,
4-(Isothiocyanato)-2,2,6,6-tetramethyl-1-piperidinyloxy free radical,
4-Maleimido-2,2,6,6-tetramethyl-1-piperidinyloxy free radical,
4-(4-Nitrobenzoyloxy)-2,2,6,6-tetramethyl-1-piperidinyloxy free radical,
4-(Phosphonooxy)-2,2,6,6-tetramethyl-1-piperidinyloxy free radical,
4-Cyano-2,2,6,6-tetramethyl-1-piperidinyloxy free radical,
3-Carbamoyl-2,2,5,5-tetramethyl-3-pyrrolinyl-1-oxy free radical,
4-Phenyl-2,2,5,5-tetramethyl-3-imidazolin-1-yloxy 3-oxide free radical,
4-Carbamoyl-2,2,5,5-tetramethyl-3-imidazolin-1-yloxy 3-oxide free radical,
4-Phenacylidene-2,2,5,5-tetramethyl-1-imidazolidinyloxy,
3-(Aminomethyl)-2,2,5,5-tetramethyl-N-pyrrolidinyloxy,
3-Carbamoyl-2,2,5,5-tetramethyl-N-pyrrolidinyloxy,
3-Carboxy-2,2,5,5-tetramethyl-N-pyrrolidinyloxy,
3-Cyano-2,2,5,5-tetramethyl-N-pyrrolidinyloxy,
3-Maleimido-2,2,5,5-tetramethyl-N-pyrrolidinyloxy and
3-(4-Nitrophenoxycarbonyl)-2,2,5,5-tetramethyl-N-pyrrolidinyloxy.

Preference for use as mediators is given to
2,2,6,6-Tetramethyl-1-piperidinyloxy free radical (TEMPO),
4-Hydroxy-2,2,6,6-tetramethyl-1-piperidinyloxy free radical,
4-Oxo-2,2,6,6-tetramethyl-1-piperidinyloxy free radical,
4-Acetamido-2,2,6,6-tetramethyl-1-piperidinyloxy free radical,
4-(Isothiocyanato)-2,2,6,6-tetramethyl-1-piperidinyloxy free radical,
4-Maleimido-2,2,6,6-tetramethyl-1-piperidinyloxy free radical,
4-(4-Nitrobenzoyloxy)-2,2,6,6-tetramethyl-1-piperidinyloxy free radical,
4-(Phosphonooxy)-2,2,6,6-tetramethyl-1-piperidinyloxy free radical,
4-Cyano-2,2,6,6-tetramethyl-1-piperidinyloxy free radical,
3-Carbamoyl-2,2,5,5-tetramethyl-3-pyrrolinyl-1-oxy free radical,
4-Phenyl-2,2,5,5-tetramethyl-3-imidazolin-1-yloxy 3-oxide free radical,
4-Carbamoyl-2,2,5,5-tetramethyl-3-imidazolin-1-yloxy 3-oxide free radical,
4-Phenacylidene-2,2,5,5-tetramethyl-1-imidazolidinyloxy.

Special preference for use as mediators is given to
2,2,6,6-Tetramethyl-1-piperidinyloxy free radical (TEMPO) and
4-Hydroxy-2,2,6,6-tetramethyl-1-piperidinyloxy free radical.

Useful mediators further include compounds of the general formula (XXXVI): 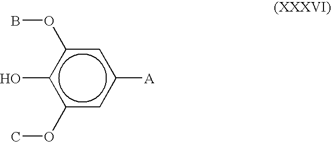
where
A denotes a -D, —CH═CH-D, —CH═CH—CH═CH-D, —CH═N-D, or —N═CH-D group, where D denotes a —CO-E, —SO₂-E, —N—XY or —N⁺—XYZ group wherein E denotes either hydrogen, hydroxyl, a —R or —OR radical and X, Y and Z are the same or different and hydrogen or a —R radical, where R is a C₁-C₁₆-alkyl radical, preferably a C₁-C₈-alkyl radical, and alkyl is in each case saturated or unsaturated, straight-chain or branched and optionally carboxyl, sulfo or amino substituted; and
B and C are the same or different and represent a CₘH₂ₘ₊₁ group where 1≦m≦5.

In one preferred embodiment A in the general formula (XXXVI) represents a —CO-E group wherein E is hydrogen, hydroxyl, a —R or —OR radical, wherein R is a C₁-C₁₆-alkyl radical and preferably a C₁-C₈-alkyl radical, and alkyl is in each case saturated or unsaturated, straight-chain or branched and optionally substituted by a carboxyl, sulfo or amino group and B and C are the same or different and signify a group CₘH₂ₘ₊₁ where 1≦m≦5.

In the general formula (XXXVI), A may also be situated in meta to the hydroxyl group instead of being disposed in the para position as shown in the formula (XXXVI).

Particular preference is given to mediators of the general formula (XXXVI) which are acetosyringon (3,5-dimethoxy-4-hydroxyacetophenone), methyl syringate, ethyl syringate, propyl syringate, butyl syringate, hexyl syringate or octyl syringate.

In summary, the following mediators are particularly preferred:
3-Amino-N-hydroxyphthalimide,
4-Amino-N-hydroxyphthalimide,
N-Hydroxy phthalimide,
3-Hydroxy-N-hydroxyphthalimide,
3-Methoxy-N-hydroxyphthalimide,
3,4-Dimethoxy-N-hydroxyphthalimide,
4,5-Dimethoxy-N-hydroxyphthalimide,
3,6-Dihydroxy-N-hydroxyphthalimide,
3,6-Dimethoxy-N-hydroxyphthalimide,
3-Methyl-N-hydroxyphthalimide,
4-Methyl-N-hydroxyphthalimide,
3,4-Dimethyl-N-hydroxyphthalimide,
3,5-Dimethyl-N-hydroxyphthalimide,
3,6-Dimethyl-N-hydroxyphthalimide,
3-Isopropyl-6-methyl-N-hydroxyphthalimide,
3-Nitro-N-hydroxyphthalimide,
4-Nitro-N-hydroxyphthalimide,
1-Hydroxybenzotriazole and its salts,
1-Hydroxybenzotriazole-4-sulfonic acid and salts thereof,
1-Hydroxybenzotriazole-5-sulfonic acid and salts thereof,
1-Hydroxybenzotriazole-6-sulfonic acid and salts thereof,
1-Hydroxybenzotriazole-7-sulfonic acid and salts thereof,
1-Hydroxybenzotriazole-4-carbonic acid and salts thereof,
1-Hydroxybenzotriazole-5-carbonic acid and salts thereof,
1-Hydroxybenzotriazole-6-carbonic acid and salts thereof,
1-Hydroxybenzotriazole-7-carbonic acid and salts thereof, Violuric acid,
N-Hydroxyacetanilide,
3-Nitrosoquinoline-2,4-diol,
2,4-Dihydroxy-3-nitrosopyridine,
2,6-Dihydroxy-3-nitrosopyridine,
2,4-Dinitroso-1,3-dihydroxybenzene,
2-Nitroso-1-naphthol-3-sulfonic acid,
1-Nitroso-2-naphthol-3,6-disulfonic acid, and
Methyl syringate.

Very particularly preferred mediators are:
N-Hydroxyphthalimide,
1-Hydroxybenzotriazole,
1-Hydroxybenzotriazole-6-sulfonic acid and salts thereof.
Methyl syringate
Violuric acid,
N-Hydroxyacetanilide,
Nitrosonaphthols,
Nitrosopyridinols and their above-recited derivates.

The macrocyclic metal complex is used in the inventively used oxidizing system in an amount in the range from 0.01 μM to 1000 μM. Preference is given to an amount in the range from 0.1 μM to 100 μM.

The oxidizing agent is used in the inventively used oxidizing system in an amount in the range of 0.01-1000 mM. Preference is given to an amount in the range of 0.1-100 ppm.

The oxidation-enhancing compound is used in the oxidizing system of the invention in an amount in the range from 0.1 μM-50 mM. The range of 1 μM-1 mM is preferred. The range from 10 μM-0.5 mM is particularly preferred.

The invention further provides a process for oxidizing oxidizable substances which is characterized in that the oxidizable substance is contacted with a specific oxidizing system, the specific oxidizing system comprising a macrocyclic metal complex, an oxidizing agent and an oxidation-enhancing compound as defined above.

The oxidizing system of the invention is used for example in the following oxidation reactions:
to remove colored impurities from industrial wastewater, preferably from wastewater of the paper- or textile-processing industry,
to lighten colored impurities on solid materials, preferably on textiles, paper or leather,
to decolorize excess, unfixed dyes from dyed textile materials,
to inhibit unwanted mutual dye transfer during the washing of differently dyed textiles.

The invention accordingly further provides a process for removing excess, unfixed dye from textile materials after a dyeing, preferably after a reactive dyeing, the process being characterized in that the dyed textile material is contacted with the oxidizing system of the invention in at least one of the post-dyeing rinse steps.

It is advantageous that this process makes it possible to remove excess, unfixed dye from the textile without decolorizing the dyed textile itself.

The coloring of the textile material can be through dyeing or printing and will hereinafter be collectively referred to as “dyeing”.

Preferably, the dyed textile material is contacted with the oxidizing system of the invention in at least one of the post-dyeing rinse steps by at least one of the rinse liquors having added to it
1) the three components of the oxidizing system individually in any desired order in succession or else individually and concurrently, or
2) initially the two components of the macrocyclic metal complex and of the oxidation-enhancing compound either individually and concurrently or else as a conjoint formulation and subsequently the oxidizing agent or
3) initially the two components of the oxidizing agent and of the oxidation-enhancing compound either individually and concurrently or else as a conjoint formulation and subsequently the macrocyclic metal complex.

In the abovementioned variant 1, at least one of the rinse liquors and preferably one rinse liquor has all three components of the oxidizing system added to it individually in any desired order in succession or else individually and concurrently.

In the abovementioned variant 2, at least one of the rinse liquors and preferably one rinse liquor initially has the two components of the macrocyclic metal complex and of the oxidation-enhancing compound added to it either individually and concurrently or else as a conjoint formulation before the oxidizing agent is added.

In this variant 2, it is advantageous to ensure thorough mixing through of the system after the addition of the two components of the macrocyclic metal complex and of the oxidation-enhancing compound. The oxidative decolorization is subsequently started by the addition of the oxidizing agent. On conclusion of the decolorization, the rinse liquor is dropped and the textile is if appropriate washed a further time with water.

In the abovementioned variant 3, initially the two components of the oxidizing agent and of the oxidation-enhancing compound are added either individually and concurrently or else as a conjoint formulation before the macrocyclic metal complex is added.

Again, a short phase of mixing through before the macrocyclic metal complex is added will prove advantageous.

When the macrocyclic metal complex is added individually in the three variants mentioned above, it is typically added in the form of an aqueous solution to which may optionally have been added 0.5-40% by weight, based on the entire solution, of a pH stabilizer and of a water-soluble or at least partially water-soluble solvent. As suitable water-soluble solvents there may be mentioned ethanol, methanol, isopropanol, ethylene glycol, diethylene glycol, polyethylene glycols, ethylene glycol monoethyl ether, ethylene glycol monomethyl ether, diethylene glycol monobutyl ether, acetone, acetonitrile, acetamide, tetrahydrofuran, dioxane, dimethyl sulfoxide, dimethylformamide, sulfolane or mixtures thereof. Suitable pH stabilizers are phosphate, citrate buffer, carbonate buffer or borate buffer, or mixtures thereof.

When hydrogen peroxide is used as oxidizing agent, it is used in the form of for example commercially available aqueous solutions having an assay of 3-50%.

When the oxidation-enhancing compound is added individually in the three variants mentioned above, it can be added to the rinse liquor in solid form. But it is possible and preferable to add the oxidation-enhancing compound in the form of a dispersion or solution, more preferably in the form of an aqueous solution to which may optionally have been added 0.5-40% by weight, based on the entire solution, of a pH stabilizer and of a water-soluble or at least partially water-soluble solvent. As suitable water-soluble solvents there may be mentioned ethanol, methanol, isopropanol, ethylene glycol, diethylene glycol, polyethylene glycols, ethylene glycol monoethyl ether, ethylene glycol monomethyl ether, diethylene glycol monobutyl ether, acetone, acetonitrile, acetamide, tetrahydrofuran, dioxane, dimethyl sulfoxide, dimethylformamide, sulfolane or mixtures thereof. Suitable pH stabilizers are phosphate, citrate buffer, carbonate buffer or borate buffer, or mixtures thereof.

When, as per variant 2, the macrocyclic metal complex and the oxidation-enhancing compound are used in a conjoint, preferably aqueous formulation, this aqueous formulation will include the macrocyclic metal complex in a concentration of 0.01-100 mM and the oxidation-enhancing compound in a concentration of 1-1000 mM.

When, as per variant 3, the oxidizing agent and the oxidation-enhancing compound are used in a conjoint, preferably aqueous formulation, this aqueous formulation will include the oxidizing agent in a concentration of 0.1-20% by weight and the oxidation-enhancing compound in a concentration of 0.1-20% by weight.

These aqueous formulations of macrocyclic metal complex and oxidation-enhancing compound (variant 2) or of oxidizing agent and oxidation-enhancing compound (variant 3) are prepared by mixing the two respective components of the oxidizing system of the invention and also if appropriate one or more of the hereinbelow identified additives in any order using water as a solvent.

Useful additives include detersive substances, preferably surfactants, sequestrants, defoamers, enzymes, such as amylases, pectinases, proteases, peroxidase, laccases or lipases, water-conditioning agents, such as water softeners, pH stabilizers, such as phosphate, citrate buffer, carbonate buffer or borate buffer, or mixtures thereof, or solvents which are soluble or at least partially soluble in water. Suitable water-soluble solvents are ethanol, methanol, isopropanol, ethylene glycol, diethylene glycol, polyethylene glycols, ethylene glycol monoethyl ether, ethylene glycol monomethyl ether, diethylene glycol monobutyl ether, acetone, acetonitrile, acetamide, tetrahydrofuran, dioxane, dimethyl sulfoxide, dimethylformamide, sulfolane or mixtures thereof.

Such additives are used at 0-50% by weight and preferably 0.01-30% by weight, based on the entire formulation.

It is particularly preferable for the oxidizing system of the invention to be contacted with the textile in one of the post-dyeing rinse steps according to one of the three variants identified above.

The treatment time using the oxidizing system of the invention depends on the type and amount of excess dye to be decolorized. Generally, 2-60 min are sufficient. If appropriate, a further addition of either any one or all of the components of the oxidizing system of the invention can be advantageous during the treatment.

The dyed textile materials may be cotton, filament viscose, staple viscose, lyocell, wool, silk, polyester, polyamide, polyacrylonitrile and elastane or blends thereof. The dyed textile materials are more preferably cotton, filament viscose and lyocell or blends thereof with polyester, polyamide or elastane.

The dyeing may be a dyeing with any commercially available dye. Useful dyes include reactive dyes, direct dyes, substantive dyes, acid dyes, metal complex dyes, disperse dyes, vat dyes and sulfur dyes.

The dyeings in question are preferably dyeings with water-soluble dyes and more preferably dyeings with reactive dyes.

The process for removing excess, unfixed dye is typically carried out at a temperature of 25-95° C. and preferably carried out at a temperature of 40-80° C. The pH in the rinse liquor is in the range of 4-13, preferably 5-12 and more preferably 7-11.

The invention further provides a process for removing colored impurities from industrial wastewater, preferably from wastewater of the paper- or textile-processing industry, the process being characterized in that the industrial wastewater is contacted with the oxidizing system of the invention.

Preferably, the industrial wastewater is contacted with the oxidizing system of the invention by adding to the industrial wastewater
1) the three components of the oxidizing system individually in any desired order in succession or else individually and concurrently, or
2) initially the two components of the macrocyclic metal complex and of the oxidation-enhancing compound either individually and concurrently or else as a conjoint formulation and subsequently the oxidizing agent or
3) initially the two components of the oxidizing agent and of the oxidation-enhancing compound either individually and concurrently or else as a conjoint formulation and subsequently the macrocyclic metal complex.

The addition of the oxidizing system to the wastewater is in principle subject to the same remarks as the previously described variants 1-3 of the process for removing excess, unfixed dye from textile materials after a dyeing.

The treatment time of the industrial wastewater depends on the type and severity of contamination. Generally, 2-60 min are sufficient. If appropriate, a further addition of either any one or all of the components of the oxidizing system of the invention can be helpful during the treatment.

The process for removing colored impurities in industrial wastewaters is typically carried out at a temperature of 25-95° C. and preferably carried out at a temperature of 40-80° C. The pH in the wastewater is in the range of 4-13, preferably 5-12 and more preferably 7-11.

The invention further provides a process for lightening colored impurities on solid materials, preferably on textiles, paper or leather, the process being characterized in that the solid materials are contacted with the oxidizing system of the invention.

These colored impurities are impurities and stains which are not attributable to dye as were described for the abovementioned process for removing excess dye from dyed textiles.

Preferably, the solid material is contacted with the oxidizing system of the invention by introducing the solid material into an aqueous liquor and adding
1) the three components of the oxidizing system individually in any desired order in succession or else individually and concurrently, or
2) initially the two components of the macrocyclic metal complex and of the oxidation-enhancing compound either individually and concurrently or else as a conjoint formulation and subsequently the oxidizing agent or
3) initially the two components of the oxidizing agent and of the oxidation-enhancing compound either individually and concurrently or else as a conjoint formulation and subsequently the macrocyclic metal complex.

The addition of the oxidizing system to the aqueous liquor holding the material to be lightened is in principle subject to the same remarks as the previously described variants 1-3 of the process for removing excess, unfixed dye from textile materials after a dyeing.

The treatment time of the liquor of the material to be lightened depends on the type and severity of contamination to be lightened. Generally, 2-60 min are sufficient. If appropriate, a further addition of either any one or all of the components of the oxidizing system of the invention can be helpful during the treatment.

The process for lightening colored impurities on solid materials is typically carried out at a temperature of 25-95° C. and preferably carried out at a temperature of 40-80° C. The pH in the aqueous liquor is in the range of 4-13, preferably 5-12 and more preferably 7-11.

### EXAMPLES

The examples utilize a macrocyclic metal complex 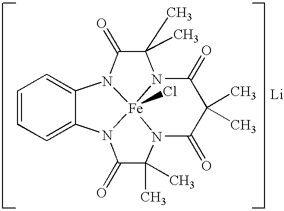
which is prepared by the method described in Examples 1-6 of WO-A-02/16330. This compound is hereinbelow referred to as 1b.

### Examples 1-7

The advantageous effect of the oxidizing system according to the invention is demonstrated using the decolorization of various dyes as an example. The “decolorization” is reported in the examples in terms of the percentage decrease in absorbance (=coloredness) measured at the absorbance peak. The higher the reported percentage, the better the decolorization. The tests are performed by adding in succession with stirring the macrocyclic metal complex, the oxidation-enhancing compound and the oxidizing agent to an initial charge of the aqueous dye solution.

The dye solution contains 30 mg/l of dye, the pH is set by a phosphate or borate buffer. The decolorization is monitored via a spectrophotometer. The various dye types of the Remazol® and Levafix® series are dyes from DyStar GmbH Deutschland Co & KG.

The oxidizing system utilizes the following concentrations, based on the solution to be decolorized:

Compound 1b=1 μM

Hydrogen peroxide=2 mM

Oxidation-enhancing compound=100 μM

### Example 1

Decolorization of Levafix Brilliant Red E-BA after 10 min at pH=9.0 and 25° C.

| | Components in | |
|---|---|---|
| Example | oxidizing system | Absorbance (%) |
| Comparison | 1b + H₂O₂ | 30 |
| 1-1 | 1b + H₂O₂ + HOBT | 99 |
| 1-2 | 1b + H₂O₂ + violuric acid | 94 |
| 1-3 | 1b + H₂O₂ + methyl syringate | 82 |

### Example 2

Decolorization of Levafix Brilliant Red E-BA after 10 min at pH=8.3 and 25° C.

| | Components in | |
|---|---|---|
| Example | oxidizing system | Absorbance (%) |
| Comparison | 1b + H₂O₂ | 43 |
| 2-1 | 1b + H₂O₂ + HOBT | 99 |

### Example 3

Decolorization of Remazol Brilliant Yellow 4GL after 10 min at pH=7.0 and 25° C.

| | Components in | |
|---|---|---|
| Example | oxidizing system | Absorbance (%) |
| Comparison | 1b + H₂O₂ | 2 |
| 3-1 | 1b + H₂O₂ + violuric acid | 18 |
| 3-2 | 1b + H₂O₂ + methyl syringate | 25 |

### Example 4

Decolorization of Remazol Brilliant Yellow 4GL after 10 min at pH=8.3 and 25° C.

| | Components in | |
|---|---|---|
| Example | oxidizing system | Absorbance (%) |
| Comparison | 1b + H₂O₂ | 35 |
| 4-1 | 1b + H₂O₂ + HOBT | 63 |

### Example 5

Decolorization of Remazol Brilliant Yellow 4GL after 10 min at pH=9.0 and 25° C.

| | Components in | |
|---|---|---|
| Example | oxidizing system | Absorbance (%) |
| Comparison | 1b + H₂O₂ | 37 |
| 5-1 | 1b + H₂O₂ + HOBT | 66 |
| 5-2 | 1b + H₂O₂ + violuric acid | 85 |
| 5-3 | 1b + H₂O₂ + methyl syringate | 89 |

### Example 6

Decolorization of Remazol Brilliant Red 3BS at pH=8.3 and 25° C. after various times

| | Components in | Absorbance in % after t = | | | |
|---|---|---|---|---|---|
| Example | oxidizing system | 3 min | 5 min | 10 min | 30 min |
| Comparison | 1b + H₂O₂ | 3% | 4% | 7% | 11% |
| 6-1 | 1b + H₂O₂ + HOBT | 58% | 77% | 89% | 97% |

### Example 7

Decolorization of Remazol Brilliant Red 3BS at pH=8.3 and 50° C. after various times

| | Components in | Absorbance in % after t = | | | |
|---|---|---|---|---|---|
| Example | oxidizing system | 3 min | 5 min | 10 min | 30 min |
| Comparison | 1b + H₂O₂ | 6% | 9% | 10% | 11% |
| 7-1 | 1b + H₂O₂ + HOBT | 96% | 98% | 98% | 98% |

### Examples 8

The examples hereinbelow describe the use of the oxidizing system according to the invention in a preferred application, the decolorization of rinse liquors following a textile dyeing in the presence of the dyed textile.

The fabric used is a scoured and bleached cotton formed-loop knit which is dyed in a laboratory dyeing machine (a Mathis Spectradye for example) at a liquor ratio of 10:1 using the following recipe:

10 g of cotton are pretreated in a liquor consisting of

0.4 g/l of RESPUMIT® NF
0.5 g/l of PERSOFTAL® L and
55 g/l of sodium chloride
   at 25° C. for 10 minutes. The temperature is raised to 30° C., when
4% on weight of fiber of LEVAFIX® Brilliant Red E-RN
   is added in 2 portions after 10 and 20 minutes, respectively. This is followed by the addition of
9.5 g/l of sodium carbonate
   in three portions at intervals of 5 minutes in each case. After heating to 60° C. at 1° C./min, the fabric is finally treated at 60° C. for 60 minutes.

Immediately following the dyeing, the dyed cotton knit is rinsed in a liquor ratio of 10:1 as follows:
(1) drop the dyeing liquor
(2) add fresh water, rinse at 60° C. for 10 minutes, drop the liquor
(3) add fresh water, rinse at 95° C. for 10 minutes, drop the liquor
(4) add fresh water, rinse at 90° C. for 10 minutes, drop the liquor
(5) add fresh water together with
   1 μM of compound 1b and
   130 μM of 1-hydroxybenzotriazole (HOBT)
   treat at 60° C. for 5 minutes, add
   4.4 mM of hydrogen peroxide
   treat at 60° C. for 10 minutes, drop the liquor
(6) add fresh water, rinse at 40° C. for 10 minutes, drop the liquor and
(7) centrifuge and dry the cotton knit.

A comparative test is performed without addition of HOBT in the 5th rinse step. Otherwise all the steps are carried out in the same way.

The table below shows the coloredness of the individual rinse liquors (determined as absorbance E at 550 nm; the lower the absorbance, the lower the coloredness:

| | Inventive | Comparative test |
|---|---|---|
| E at 550 nm | process | - without HOBT - |
| 1st rinse step | ca. 13 | ca. 13 |
| 2nd rinse step | ca. 9.5 | ca. 9.5 |
| 3rd rinse step | ca. 3.8 | ca. 3.8 |
| 4th rinse step | 0.18 | 1.23 |
| 5th rinse step | 0.02 | 0.29 |

The results clearly show the significantly better decolorization of the rinse liquor in bath 4 in the presence of HOBT and the attendant lower coloredness of the last rinse liquor for the inventive process.

The wash-off effect is evaluated by determining the water fastness of the dyeing in accordance with German standard specification DIN 54006 (water fastness of dyeings, severe exposure). Cotton is used as adjacent fabric. The evaluation scale goes from 1 to 5, where 5 denotes the best fastness.

| | Inventive | Comparative test |
|---|---|---|
| | process | without HOBT |
| Rating | 3-4 | 2-3 |

The inventive process accordingly provides a water fastness which is distinctly improved, namely by one rating point.

1. An oxidizing system comprising the three components
1) a macrocyclic metal complex of the general formula (I) 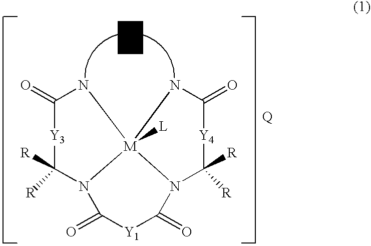
where
Y₁, Y₃ and Y₄ are each independently a single bond or a bridge member which contains 1, 2 or 3 carbon atoms in the bridge,
Y₂ is a bridge member having at least 1 carbon atom in the bridge,
R is independently in each occurrence hydrogen, alkyl, cycloalkyl, cycloalkenyl, alkenyl, aryl, alkynyl, alkylaryl, halogen, alkoxy, phenoxy, CH₂CF₃ or CF₃ or two R radicals which are bound to the same carbon atom combine to form a substituted or unsubstituted benzene, cycloalkyl or cycloalkenyl ring, the carbon atom to which the two R radicals are bound being part of the benzene, cycloalkyl or cycloalkenyl ring,
M is a transition metal in the oxidation states I, II, III, IV, V or VI or is selected from groups 6, 7, 8, 9, 10 and 11 of the periodic table,
Q is a counterion which balances the charge of the macrocyclic metal complex on a stoichiometric basis, and
L is a further ligand.
2) an oxidizing agent, and
3) an oxidation-enhancing compound.

2. The oxidizing system according to claim 1 which is characterized in that in the general formula (1)
Y₁, Y₃ and Y₄ are each independently a (—CH₂—)ₓ group, where x is 1, 2 or 3 and one or more hydrogen atoms in the (—CH₂—)ₓ group may be substituted by an Rⁱ radical, Rⁱ being alkyl, cycloalkyl, cycloalkenyl, alkenyl, aryl, alkynyl, alkylaryl, halogen, alkoxy or phenoxy, or two Rⁱ radicals which are bound to two adjacent carbon atoms of the (—CH₂—)ₓ group combine to form a benzene, cycloalkyl or cycloalkenyl ring which may contain one or more hetero atoms, preferably oxygen, sulfur or nitrogen.

3. The oxidizing system according to claim 1 or 2 which is characterized in that in the general formula (1)
Y₂ is a bridge member having 1, 2 or 3 carbon atoms in the bridge, preferably a (—CH₂—)_{y} group, where y is 1 or 2 and one or more hydrogen atoms in the (—CH₂—)ₓ group may be substituted by an Rⁱⁱ radical, Rⁱⁱ being alkyl, cycloalkyl, cycloalkenyl, alkenyl, aryl, alkynyl, alkylaryl, halogen, alkoxy or phenoxy, or two Rⁱⁱ radicals which are bound to two adjacent carbon atoms of the (—CH₂—)ₓ group combine to form an optionally substituted benzene, cycloalkyl or cycloalkenyl ring which may contain one or more hetero atoms, preferably oxygen, sulfur or nitrogen, preferably a benzene ring which may be substituted by electron-donating or electron-withdrawing radicals.

4. The oxidizing system according to one or more of claims 1-3 which is characterized in that in the general formula (1)
the R radicals are each independently hydrogen, C₁-C₈-alkyl, C₃-C₈-cycloalkyl, C₄-C₁₂-cycloalkenyl, C₂-C₈-alkenyl, C₆-C₁₄-aryl, C₂-C₁₂-alkynyl, C₁-C₁₂-alkylaryl, halogen, alkoxy, phenoxy, CH₂CF₃ or CF₃ or two R radicals which are bound to the same carbon atom combine to form a substituted or unsubstituted benzene, C₃-C₈-cycloalkyl or C₄-C₁₂-cycloalkenyl ring, the carbon atom to which the two R radicals are bound being part of the benzene, cycloalkyl or cycloalkenyl ring.

5. The oxidizing system according to one or more of claims 1-4 which is characterized in that in the general formula (1) M represents Cr, Mo, W, Mn, Fe, Ru, Os, Co, Rh, Ir, Ni, Pd and/or Pt or mixtures of metals of the aforementioned oxidation states or from the identified groups of the periodic table.

6. The oxidizing system according to one or more of claims 1-5 which is characterized in that in the general formula (1) Q is an alkali metal counterion, preferably potassium, lithium or sodium, NRⁱⁱⁱ₄⁺ or PRⁱⁱⁱ₄⁺, where every Rⁱⁱⁱ is independently hydrogen, alkyl, aryl, alkylaryl, alkenyl or joins to form a cycloalkyl, cycloalkenyl or an aryl ring which optionally contains one or more hetero atoms, preferably oxygen, sulfur or nitrogen.

7. The oxidizing system according to one or more of claims 1-6 which is characterized in that in the general formula (1) L is a labile ligand, preferably H₂O, Cl or CN.

8. The oxidizing system according to claim 1 which is characterized in that a macrocyclic metal complex used has the general formula (1A) 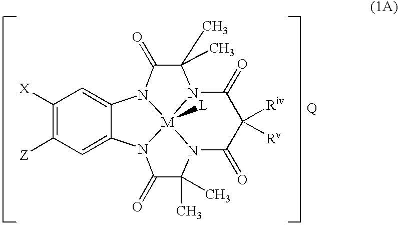
where
X and Z are each independently hydrogen, electron-donating or electron-withdrawing groups,
R^{iv} and R^{v} are each independently hydrogen, alkyl, cycloalkyl, cycloalkenyl, alkenyl, aryl, alkynyl, alkylaryl, halogen, alkoxy or phenoxy radicals or combine to form a cycloalkyl or cycloalkenyl ring which may contain one or more hetero atoms,
M is a transition metal of the oxidation states I, II, III, IV, V or VI or is selected from groups 6, 7, 8, 9, 10 or 11 of the periodic table,
Q is a counterion which balances the charge of the macrocyclic metal complex on a stoichiometric basis, and
L is a further ligand.

9. The oxidizing system according to claim 8 which is characterized in that X and Z in the general formula (1A) are each independently halogen, preferably chlorine, bromine or iodine, SO₃⁻, OSO₃⁻, OSO₃R^{vi} (where R^{vi} is hydrogen, alkyl, aryl or alkylaryl), NO₂⁻, C₁-C₈-alkoxy, preferably methoxy, ethoxy, propoxy and butoxy, C₁-C₈-alkyl, preferably methyl, ethyl, propyl, n-butyl and tert-butyl, or hydrogen.

10. The oxidizing system according to claim 8 or 9 which is characterized in that in the macrocyclic metal complex of the general formula (1A) R^{iv} and R^{v} are each independently hydrogen, alkyl, preferably C₁-C₅-alkyl, more preferably both identically methyl or ethyl, cycloalkyl, cycloalkenyl, alkenyl, aryl, alkynyl, halogen, alkoxy or phenoxy radicals or combine to form a cycloalkyl ring, especially a cyclopentyl or cyclohexyl ring, or a cycloalkenyl ring, the cycloalkyl or cycloalkenyl ring optionally containing one or more hetero atoms, preferably oxygen, sulfur or nitrogen.

11. The oxidizing system according to one or more of claims 1-10 which is characterized in that the oxidizing agent comprises hydrogen peroxide, hydrogen peroxide adducts, preferably alkali metal, especially sodium, lithium or potassium, carbonate peroxyhydrate, urea peroxide or compounds capable of releasing or generating hydrogen peroxide in aqueous solution, preferably alkali metal, especially sodium, potassium or lithium perborate (as mono- or tetrahydrate), organic peroxides, preferably benzoyl or cumene hydroperoxides, persulfates, preferably peroxymonosulfate or Carot's acid, perphosphates or persilicates.

12. The oxidizing system according to one or more of claims 1-11 which is characterized in that the oxidation-enhancing compounds (“mediator”) are aliphatic, cycloaliphatic, heterocyclic or aromatic compounds having at least one OH, NO, NOH, HRN—OH functionality or mixtures thereof.

13. The oxidizing system according to one or more of claims 1-12 which is characterized in that the oxidation-enhancing compounds are compounds of the general formula (I) 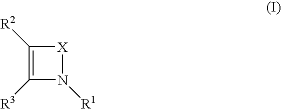
where X represents (—N═N—), (—N═CR⁴—)ₚ, (—CR⁴═N—)ₚ, (—CR⁵═CR⁶)ₚ, 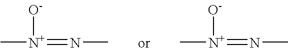
and p is 1 or 2,
where the radicals R¹ to R⁶ be the same or different and each independently denote hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, sulfo and also esters and salts thereof, sulfamoyl, carbamoyl, phospho, phosphono, phosphonooxy and also salts and esters thereof, where the amino, carbamoyl and sulfamoyl groups of the radicals R¹ to R⁶ may be unsubstituted or singly or doubly hydroxyl, C₁-C₃-alkyl or C₁-C₃-alkoxy substituted, and where the radicals R² and R³ may combine to form a conjoint group -A- and -A- is (—CR⁷═CR⁸—CR⁹═CR¹⁰—) or (—CR¹⁰═CR⁹—CR⁸═CR⁷—), where the radicals R⁷ to R¹⁰ are the same or different and each independently denote hydrogen, halogen, hydroxyl, formyl, carboxyl and also salts and esters thereof, amino, nitro, C₁-C₁₂-alkyl, C₁-C₆-alkyloxy, carbonyl-C₁-C₅-alkyl, phenyl, aryl, sulfo and also esters and salts thereof, sulfamoyl, carbamoyl, phospho, phosphono, phosphonooxy and also salts and esters thereof, where the amino, carbamoyl and sulfamoyl groups of the radicals R⁷ to R¹⁰ may be unsubstituted or singly or doubly hydroxyl, C₁-C₃-alkyl or C₁-C₃-alkoxy substituted, and where the C₁-C₁₂-alkyl, C₁-C₆-alkyloxy, carbonyl-C₁-C₆-alkyl, phenyl and aryl groups of the radicals R⁷ to R¹⁰ may be unsubstituted or singly or multiply R¹¹ substituted and where R¹¹ denotes hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, aryl, sulfo and also esters and salts thereof, where the carbamoyl, sulfamoyl and amino groups of the R¹¹ radical may be unsubstituted or singly or doubly R¹² substituted and R¹² denotes hydrogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl or aryl.

14. The oxidizing system according to one or more of claims 1-12 which is characterized in that the oxidation-enhancing compounds are compounds of the general formula (II) 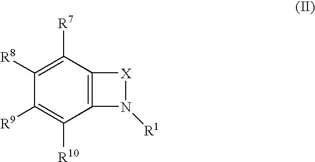
where X represents (—N═N—), (—N═CR⁴—)ₚ, (—CR⁴═N—)ₚ, (—CR⁵═CR⁶)ₚ, 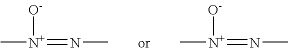
and p is 1 or 2
where the radicals R¹ and R⁴ to R¹⁰ are the same or different and denote
hydrogen, halogen, hydroxyl, formyl, carboxyl and also salts and esters thereof, amino, nitro, C₁-C₁₂-alkyl, C₁-C₅-alkyloxy, carbonyl-C₁-C₆-alkyl, phenyl, aryl, sulfo and also esters and salts thereof, sulfamoyl, carbamoyl, phospho, phosphono, phosphonooxy and also salts and esters thereof, where the amino, carbamoyl and sulfamoyl groups of the radicals R¹ and R⁴ to R¹⁰ may be unsubstituted or singly or doubly hydroxyl, C₁-C₃-alkyl or C₁-C₃-alkoxy substituted and where the C₁-C₁₂-alkyl, C₁-C₆-alkyloxy, carbonyl-C₁-C₆-alkyl, phenyl, aryl and aryl-C₁-C₆-alkyl groups of the radicals R¹ and R⁴ to R¹⁰ may be unsubstituted or singly or multiply R¹² substituted and where R¹² denotes hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, aryl, sulfo, esters and salts thereof, sulfeno, sulfino, where the carbamoyl, sulfamoyl, amino groups of the R¹² radical may be unsubstituted or singly or doubly R¹³ substituted and where R¹³ denotes hydrogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl or aryl.

15. The oxidizing system according to one or more of claims 1-12 which is characterized in that the oxidation-enhancing compounds are compounds of the general formula (III) 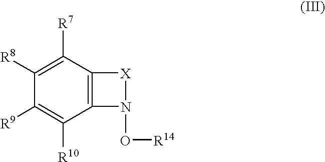
where X represents (—N═N—), (—N═CR⁴—)ₘ, (—CR⁴═N—)ₘ, (—CR⁵═CR⁶—)ₘ, 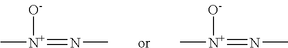
and m is 1 or 2
where the radicals R⁷ to R¹⁰ and R⁴ to R⁶ are each as defined for the formula (II) and
R¹⁴ denotes -M, where M denotes hydrogen, alkali, preferably lithium, sodium or potassium, alkaline earth, preferably calcium or magnesium, ammonium, C₁-C₄-alkylammonium or C₁-C₄-alkanolammonium, C₁-C₁₀-alkyl, C₁-C₁₀-alkylcarbonyl, where C₁-C₁₀-alkyl and C₁-C₁₀-alkylcarbonyl may be unsubstituted or singly or multiply R¹⁵ substituted, where R¹⁵ denotes hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, sulfo, and also esters and salts thereof, sulfamoyl, carbamoyl, phospho, phosphono, phosphonooxy and also salts and esters thereof, where the amino, carbamoyl and sulfamoyl groups of the R¹⁵ radical may be unsubstituted or singly or doubly hydroxyl, C₁-C₃-alkyl or C₁-C₃-alkoxy substituted.

16. The oxidizing system according to one or more of claims 1-12 which is characterized in that the oxidation-enhancing compounds are compounds of the general formula (IV) 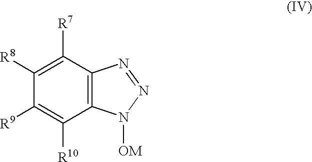
where
M denotes hydrogen, alkali, preferably lithium, sodium or potassium, alkaline earth, preferably calcium or magnesium, ammonium, C₁-C₄-alkylammonium or C₁-C₄alkanolammonium, and
the radicals R⁷ to R¹⁰ are the same or different and each independently denote hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, sulfo and also esters and salts thereof, sulfamoyl, carbamoyl, phospho, phosphono, phosphonooxy and also salts and esters thereof, where the amino, carbamoyl and sulfamoyl groups of the radicals R⁷ to R¹⁰ may be unsubstituted or singly or doubly hydroxyl, C₁-C₃-alkyl or C₁-C₃-alkoxy substituted, and where the C₁-C₁₂-alkyl, C₁-C₆-alkyloxy, carbonyl-C₁-C₅-alkyl, phenyl and aryl groups of the radicals R⁷ to R¹⁰ may be unsubstituted or singly or multiply R¹⁶ substituted and where R¹⁶ denotes hydrogen, halogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl, aryl, sulfo, salts or esters thereof, sulfeno, sulfino, where the carbamoyl, sulfamoyl and amino groups of the R¹⁶ radical may be unsubstituted or singly or doubly R¹⁷ substituted and R¹⁷ denotes hydrogen, hydroxyl, formyl, carboxyl and also salts and esters thereof, amino, nitro, C₁-C₁₂-alkyl, C₁-C₆-alkyloxy, carbonyl-C₁-C₆-alkyl, phenyl or aryl.

17. The oxidizing system according to one or more of claims 1-12 which is characterized in that the oxidation-enhancing compounds are cyclic N-hydroxy compounds comprising at least one five- or six-membered ring containing the structure identified in the general formula (V) 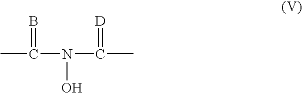
and also salts, ethers or esters thereof, where
B and D are the same or different and denote oxygen, sulfur or NR¹⁸, where
R¹⁸ represents hydrogen, hydroxyl, formyl, carbamoyl, sulfo, esters or salts thereof, sulfamoyl, nitro, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters or salts thereof, where the carbamoyl, sulfamoyl, amino and phenyl radicals may be unsubstituted or singly or multiply R¹⁹ substituted and the aryl-C₁-C₅-alkyl, C₁-C₁₂-alkyl, C₁-C₅-alkoxy, C₁-C₁₀-carbonyl and carbonyl-C₁-C₆-alkyl radicals may be saturated or unsaturated, branched or unbranched and may similarly be singly or multiply R¹⁹ substituted, where R¹⁹ in each occurrence is the same or different and denotes hydroxyl, formyl or carboxyl and also esters or salts thereof, carbamoyl or sulfo, esters or salts thereof, sulfamoyl, nitro, amino, phenyl, C₁-C₅-alkyl or C₁-C₅-alkoxy.

18. The oxidizing system according to one or more of claims 1-12 which is characterized in that the oxidation-enhancing compounds are compounds of the general formulae (VI), (VII), (VIII) or (IX) 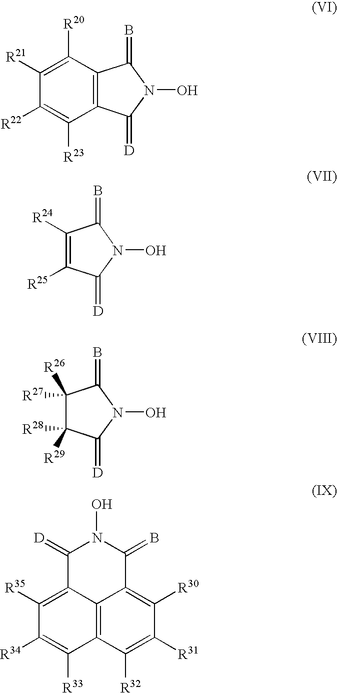
where B and D are each as defined for the general formula (V) and the radicals R²⁰-R³⁵ are the same or different and represent halogen, carboxyl and salts or esters thereof or have the meanings defined for R¹⁸, although R²⁶ and R²⁷ on the one hand and R²⁸ and R²⁹ on the other must not both denote hydroxyl or amino and optionally any two of the substituents R²⁰-R²³, R²⁴-R⁵, R²⁶-R²⁹, R³⁰-R³⁵ may be linked together to form a ring -E-, where -E- represents
(—CH═CH), with n=1 to 3, —CH═CH—CH═N— or 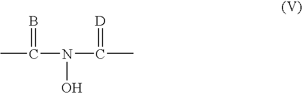
and where optionally the radicals R²⁶-R²⁹ may also be bonded together by one or two bridge elements —F—, where —F— in each occurrence is the same or different and has one of the following meanings: -0-, —S, —CH₂—, —CR³⁶═CR³⁷—, where R³⁶ and R³⁷ are the same or different and have the meaning of R²⁰.

19. The oxidizing system according to one or more of claims 1-12 which is characterized in that the oxidation-enhancing compounds are compounds of the general formulae (VI), (VII), (VIII) or (IX) wherein B and D denote oxygen or sulfur.

20. The oxidizing system according to one or more of claims 1-12 which is characterized in that the oxidation-enhancing compounds are compounds of the general formula (X), (XI) or (XII) 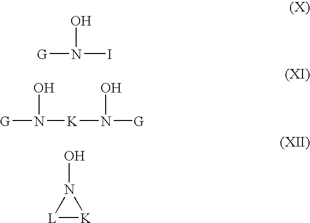
and also salts, ethers or esters thereof, where
G is a monovalent homo- or heteroaromatic mono- or binuclear radical and
L is a bivalent homo- or heteroaromatic mono- or binuclear radical and where these aromatic radicals may be substituted by one or more, identical or different R³⁸ radicals, where R³⁸ may represent halogen, hydroxyl, formyl, cyano, carbamoyl, carboxyl, esters or salts thereof, sulfo, esters or salts thereof, sulfamoyl, nitro, nitroso, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono, phosphonooxy, esters or salts thereof, where the carbamoyl, sulfamoyl, amino and phenyl radicals may in turn be unsubstituted or singly or multiply R³⁹ substituted and the aryl-C₁-C₅-alkyl, C₁-C₁₂-alkyl, C₁-C₅-alkoxy, C₁-C₁₀-carbonyl, carbonyl-C₁-C₆-alkyl radicals may be saturated or unsaturated, branched or unbranched and may similarly be singly or multiply R³⁹ substituted, where R³⁹ in each occurrence is the same or different and denotes hydroxyl, formyl, cyano, carboxyl, esters or salts thereof, carbamoyl, sulfo, sulfamoyl, nitro, nitroso, amino, phenyl, C₁-C₅-alkyl, C₁-C₅-alkoxy, C₁-C₅-alkylcarbonyl and two R³⁸ or R³⁹ radicals at a time may be linked together pairwise via a [—CR⁴⁰R⁴¹—]ₘ bridge, where m is 0, 1, 2, 3 or 4, and R⁴⁰ and R⁴¹ are the same or different and denote carboxyl, esters or salts thereof, phenyl, C₁-C₅-alkyl, C₁-C₅-alkoxy or C₁-C₅-alkylcarbonyl and one or more nonadjacent [—CR⁴⁰R⁴¹—] groups may be replaced by O, S or an optionally C₁-C₅-alkyl-substituted imino radical and two adjacent [—CR⁴⁰R⁴¹—] groups by a [—CR⁴⁰═CR⁴¹] group and denotes a monovalent acid radical present in amidic form of acids selected from the group consisting of carboxylic acids having up to 20 carbon atoms, carbonic acid, half esters of carbonic acid or of carbamic acid, sulfonic acid, phosphonic acid, phosphoric acid, monoesters of phosphoric acid, and diesters of phosphoric acid and K is a divalent acid radical present in amidic form of acids selected from the group consisting of mono- and dicarboxylic acids having up to 20 carbon atoms, carbonic acid, sulfonic acid, phosphonic acid, phosphoric acid or monoesters of phosphoric acid.

21. The oxidizing system according to one or more of claims 1-12 which is characterized in that the oxidation-enhancing compounds are compounds of the general formula (XIII), (XIV), (XV), (XVI) or (XVII) 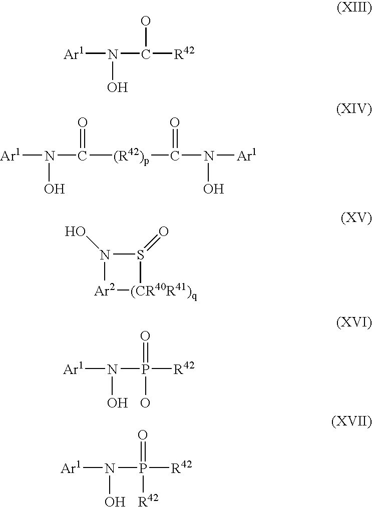
and also salts, ethers or esters thereof, where
Ar¹ denotes a univalent homo- or heteroaromatic mononuclear aryl radical and
Ar² denotes a bivalent homo- or heteroaromatic mononuclear aryl radical which may each be substituted by one or more, identical or different R⁴⁴ radicals, where R⁴⁴ represents hydroxyl, cyano, carboxyl, esters or salts thereof, sulfo, esters or salts thereof, nitro, nitroso, amino, C₁-C₁₂-alkyl, C₁-C₅-alkoxy, C₁-C₁₀-carbonyl, carbonyl or C₁-C₆-alkyl, where the amino radicals may be unsubstituted or singly or multiply R⁴⁵ substituted and the C₁-C₅-alkyl, C₁-C₅-alkoxy, C₁-C₁₀-carbonyl and carbonyl-C₁-C₆-alkyl radicals may be saturated or unsaturated, branched or unbranched and may similarly be singly or multiply R⁴⁵ substituted, where R⁴⁵ in each occurrence is the same or different and denotes hydroxyl, carboxyl, esters or salts thereof, sulfo, nitro, amino, C₁-C₅-alkyl, C₁-C₅-alkoxy or C₁-C₅-alkylcarbonyl and two R⁴⁴ radicals at a time may be linked together pairwise via a [—CR⁴⁰R⁴¹—]ₘ bridge where m is 0, 1, 2, 3 or 4, and where
R⁴⁰ and R⁴¹ are each as defined in claim 19 and one or more nonadjacent [—CR⁴⁰R⁴¹—] groups may be replaced by O, S or an optionally C₁-C₅-alkyl-substituted imino radical and two adjacent [—CR⁴⁰R⁴¹—] groups may be replaced by a [—CR⁴⁰═CR⁴¹—] group, and where
R⁴² in each occurrence is the same or different and denotes hydrogen, phenyl, aryl-C₁-C₅-alkyl, C₁-C₁₂-alkyl, C₁-C₅-alkoxy or C₁-C₁₀-carbonyl, where the phenyl radicals may be unsubstituted or singly or multiply R⁴⁶ substituted and the aryl-C₁-C₅-alkyl, C₁-C₁₂-alkyl, C₁-C₅-alkoxy, C₁-C₅-carbonyl radicals may be saturated or unsaturated, branched or unbranched and may similarly be singly or multiply R⁴⁶ substituted, where
R⁴⁶ in each occurrence is the same or different and denotes hydroxyl, formyl, cyano, carboxyl, esters or salts thereof, carbamoyl, sulfo, sulfamoyl, nitro, nitroso, amino, phenyl, C₁-C₅-alkyl or C₁-C₅-alkoxy and R⁴³ denotes divalent radicals ortho-, meta-, para-phenylene, aryl-C₁-C₆-alkyl, C₁-C₁₂-alkylene or C₁-C₅-alkylenedioxy, where the phenylene radicals may be unsubstituted or singly or multiply R⁴⁶ substituted and the aryl-C₁-C₅-alkyl, C₁-C₁₂-alkyl and C₁-C₅-alkoxy radicals may be saturated or unsaturated, branched or unbranched and may be singly or multiply R⁴⁶ substituted, where
p denotes 0 or 1 and
q denotes an integer from 1 to 3.

22. The oxidizing system according to one or more of claims 1-12 which is characterized in that the oxidation-enhancing compounds are compounds of the general formula (XVIII) or (XIX), 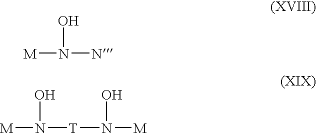
and also salts, ethers or esters thereof, where
M in each occurrence is the same or different and denotes a univalent linear or branched, cyclic or polycyclic, saturated or unsaturated C₁-C₂-alkyl radical and where this alkyl radical may be substituted by one or more R⁴⁸ radicals, where R⁴⁸ in each occurrence is the same or different and denotes hydroxyl, mercapto, formyl, carbamoyl, carboxyl, esters or salts thereof, sulfo, esters or salts thereof, sulfamoyl, nitro, nitroso, amino, hydroxylamino, phenyl, C₁-C₅-alkoxy, C₁-C₁₀-carbonyl, phospho, phosphono or phosphonooxy and also esters or salts and where the carbamoyl, sulfamoyl, amino, hydroxylamino, mercapto and phenyl radicals may be unsubstituted or singly or multiply R⁴⁸ substituted and the C₁-C₅-alkoxy and C₁-C₁₀-carbonyl radicals may be saturated or unsaturated, branched or unbranched and may be singly or multiply R⁴⁸ substituted, where R⁴⁸ in each occurrence is the same or different and denotes hydroxyl, formyl, cyano, carboxyl, esters or salts thereof, carbamoyl, sulfo, salts or esters thereof, sulfamoyl, nitro, nitroso, amino, phenyl, benzoyl, C₁-C₅-alkyl, C₁-C₅-alkoxy or C₁-C₅-alkylcarbonyl and non-α-disposed methylene groups may be replaced by O, S or an optionally monosubstituted imino radical, and
N′″ denotes a monovalent acid radical in amidic form of acids which are aliphatic, mono- or binuclear aromatic or mono- or binuclear heteroaromatic carboxylic acids having 1-20 carbon atoms, carbonic acid, half esters of carbonic acid or of carbamic acid, sulfonic acid, phosphonic acid, phosphoric acid, monoesters of phosphoric acid or diesters of phosphoric acid, and
T denotes a bivalent acid radical in amidic form of acids which are aliphatic, mono- or binuclear aromatic or mono- or binuclear heteroaromatic dicarboxylic acids having 1-20 carbon atoms, carbonic acid, sulfonic acid, phosphonic acid, phosphoric acid or monoesters of phosphoric acid, and where alkyl radicals of the aliphatic acids N′″ and T which are present in amidic form may be linear or branched, cyclic and/or polycyclic, saturated or unsaturated and contain 1-24 carbon atoms and are unsubstituted or singly or multiply R⁴⁷ substituted and where, furthermore, aryl and heteroaryl radicals of the aromatic or heteroaromatic acids N′″ and T which are present in amidic form may be substituted by one or more R⁴⁹ radicals, where R⁴⁹ may be substituted, in which case R⁴⁹ in each occurrence is the same or different and denotes hydroxyl, mercapto, formyl, cyano, carbamoyl, carboxyl, esters or salts thereof, sulfo, esters or salts thereof, sulfamoyl, nitro, nitroso, amino, phenyl, aryl-C₁-C₅-alkyl, C₁-C₁₂-alkyl, C₁-C₅-alkoxy, C₁-C₁₀-carbonyl, phospho, phosphono or phosphonooxy and also esters or salts thereof and where the carbamoyl, sulfamoyl, amino, mercapto and phenyl radicals may be unsubstituted or singly or multiply R⁴⁸ substituted and the aryl-C₁-C₅-alkyl, C₁-C₁₂-alkyl-C₁-C₅-alkoxy, C₁-C₁₀-carbonyl radicals may be saturated or unsaturated, branched or unbranched and may be singly or multiply R⁴⁸ substituted.

23. The oxidizing system according to one or more of claims 1-12 which is characterized in that the oxidation-enhancing compounds are compounds of the general formulae (XX), (XXI), (XXII) or (XXIII) 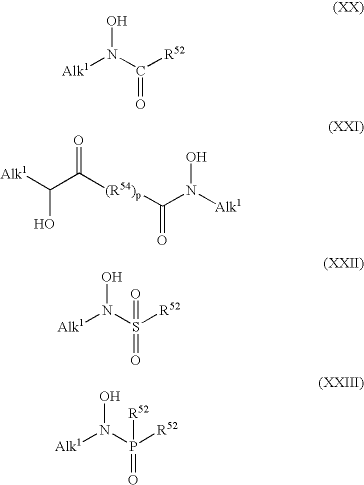
and also salts, ethers or esters thereof, where
Alk′ in each occurrence is the same or different and denotes a univalent linear or branched, cyclic or polycyclic, saturated or unsaturated C₁-C₁₀-alkyl radical,
where this alkyl radical may be substituted by one or more R⁵⁰ radicals, where R⁵⁰ in each occurrence is the same or different and denotes hydroxyl, formyl, carbamoyl, carboxyl, esters or salts thereof, sulfo, esters or salts thereof, sulfamoyl, nitro, nitroso, amino, hydroxylamino, phenyl, C₁-C₅-alkoxy, C₁-C₅-carbonyl and where the carbamoyl, sulfamoyl, amino, hydroxylamino and phenyl radicals may be unsubstituted or singly or multiply R⁵¹ substituted and the C₁-C₅-alkoxy and C₁-C₁₀-carbonyl radicals may be saturated or unsaturated, branched or unbranched and may be singly or multiply R⁵¹ substituted, where
R⁵¹ in each occurrence is the same or different and denotes hydroxyl, formyl, cyano, carboxyl, esters or salts thereof, carbamoyl, sulfo, salts or esters thereof, sulfamoyl, nitro, amino, phenyl, benzoyl, C₁-C₅-alkyl, C₁-C₅-alkoxy or C₁-C₅-alkylcarbonyl and non-α-disposed methylene groups may be replaced by O, S or an optionally monosubstituted imino radical, and where
R⁵² denotes identical or different univalent radicals hydrogen, phenyl, pyridyl, furyl, pyrrolyl, thienyl, aryl C₁-C₅-alkyl, C₁-C₁₂-alkyl, C₁-C₁₀-alkoxy or C₁-C₁₀-carbonyl, where the phenyl, pyridyl, furyl, pyrrolyl and thienyl radicals may be unsubstituted or singly or multiply R⁵³ substituted and the aryl-C₁-C₅-alkyl, C₁-C₁₂-alkyl, C₁-C₅-alkoxy and C₁-C₁₀-carbonyl radicals may be saturated or unsaturated, branched or unbranched and may similarly be singly or multiply R⁵³ substituted, where
R⁵³ in each occurrence is the same or different and denotes hydroxyl, formyl, carboxyl, esters or salts thereof, carbamoyl, sulfo, esters and salts thereof, sulfamoyl, nitro, amino, phenyl, C₁-C₅-alkyl or C₁-C₅-alkoxy, and
R⁵⁴ denotes bivalent radicals phenylene, pyridylene, thienylene, furylene, pyrrolylene, aryl-C₁-C₅-alkyl, C₁-C₁₂-alkylene, C₁-C₅-alkylenedioxy, where phenylene, pyridylene, thienylene, furylene and pyrrolylene may be unsubstituted or singly or multiply R⁵³ substituted and the aryl-C₁-C₅-alkyl, C₁-C₁₂-alkyl, C₁-C₅-alkoxy radicals may be saturated or unsaturated, branched or unbranched and may similarly be singly or multiply R⁵³ substituted, where p denotes 0 or 1.

24. The oxidizing system according to one or more of claims 1-12 which is characterized in that the oxidation-enhancing compounds are compounds of the general formulae (XXIV) or (XXV) 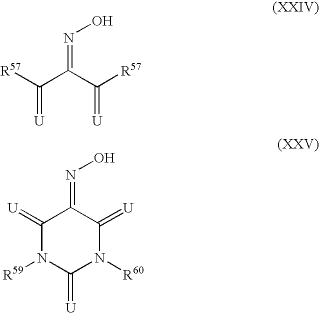
and also salts, ethers or esters thereof, where
U in each occurrence is the same or different and denotes oxygen, sulfur or NR⁵⁵, where
R⁵⁵ denotes hydrogen, hydroxyl, formyl, carbamoyl, sulfo, esters or salts thereof, sulfamoyl, nitro, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters or salts thereof,
where the carbamoyl, sulfamoyl, amino and phenyl radicals may be unsubstituted or singly or multiply R⁵⁶ substituted and the aryl-C₁-C₅-alkyl, C₁-C₁₀-alkyl, C₁-C₅-alkoxy, C₁-C₁₀-carbonyl and carbonyl-C₁-C₆-alkyl radicals may be saturated or unsaturated, branched or unbranched and may be singly or multiply R⁵⁶ substituted, where
R⁵⁶ in each occurrence is the same or different and denotes hydroxyl, formyl, carboxyl, esters or salts thereof, carbamoyl, sulfo, esters or salts thereof, sulfamoyl, nitro, amino, phenyl, C₁-C₅-alkyl or C₁-C₅-alkoxy, and
the radicals R⁵⁷ and R⁵⁸ are the same or different and denote halogen or carboxyl and also esters or salts thereof, or have the meanings defined for R⁵⁵, or are linked together to form a [—CR⁶¹R⁶²]ₙ ring, where n is 2, 3 or 4, and
R⁵⁹ and R⁶⁰ have the meanings defined for R⁵⁵, and
R⁶¹ and R⁶² are the same or different and denote halogen or carboxyl and also esters or salts thereof, or have the meanings defined for R⁵⁵.

25. The oxidizing system according to one or more of claims 1-12 which is characterized in that the oxidation-enhancing compounds are compounds of the general formulae (XXVI) or (XXVII) 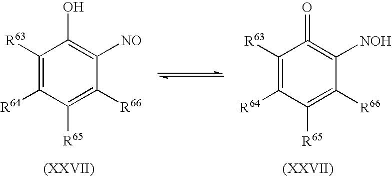
and also salts, ethers or esters thereof, where
R⁶³, R⁶⁴, R⁶⁵ and R⁶⁶ are the same or different and denote hydrogen, halogen, hydroxyl, formyl, carbamoyl or carboxyl and also esters or salts thereof, sulfo, esters or salts thereof, sulfamoyl, nitro, nitroso, cyano, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters or salts thereof, where the carbamoyl, sulfamoyl, amino and phenyl radicals may be unsubstituted or singly or multiply R⁶⁷ substituted and the aryl-C₁-C₅-alkyl, C₁-C₁₂-alkyl, C₁-C₅-alkoxy, C₁-C₁₀-carbonyl, carbonyl-C₁-C₆-alkyl radicals may be saturated or unsaturated, branched or unbranched and may be singly or multiply R⁶⁷ substituted, where
R⁶⁷ in each occurrence is the same or different and denotes hydroxyl, formyl or carboxyl and also esters or salts thereof, carbamoyl, sulfo, salts or esters thereof, sulfamoyl, nitro, nitroso, amino, phenyl, C₁-C₅-alkyl or C₁-C₅-alkoxy or the R⁶³, R⁶⁴, R⁶⁵ and R⁶⁶ radicals are linked together pairwise to form a [—CR⁶⁸R⁶⁹—]ₘ ring, where m is an integer from 1 to 4, or to form a [—CR⁷⁰═CR⁷¹—], ring, where n is an integer from 1 to 3, and
R⁶⁸, R⁶⁹, R⁷⁰ and R⁷¹ are the same or different and have the meanings defined for R⁶³ to R⁶⁶.

26. The oxidizing system according to one or more of claims 1-12 which is characterized in that the oxidation-enhancing compounds are compounds of the general formulae (XXVIII), (XXIX) or (XXX) 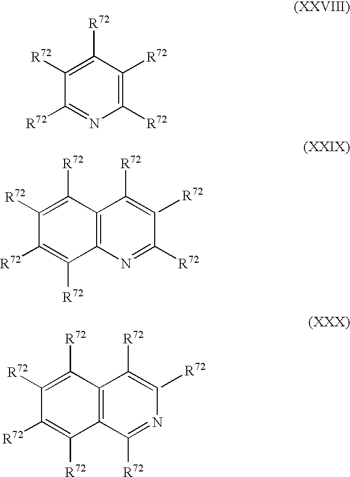
and also tautomers, salts, ethers or esters thereof, where in the formulae (XXVIII), (XXIX) and (XXX) two mutually ortho- or para-disposed R⁷² radicals denote hydroxyl and nitroso or hydroxyl and mercapto or nitroso and amino and the other R⁷² radicals are the same or different and denote hydrogen, halogen, hydroxyl, mercapto, formyl, cyano, carbamoyl or carboxyl and also esters and salts thereof, sulfo, esters and salts thereof, sulfamoyl, nitro, nitroso, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters and salts thereof and where the carbamoyl, sulfamoyl, amino, mercapto and phenyl radicals may be unsubstituted or singly or multiply R⁷³ substituted and the aryl-C₁-C₅-alkyl, C₁-C₁₂-alkyl, C₁-C₅-alkoxy, C₁-C₁₀-carbonyl, carbonyl-C₁-C₆-alkyl radicals may be saturated or unsaturated, branched or unbranched and may be singly or multiply R⁷³ substituted, where R⁷³ in each occurrence is the same or different and denotes hydroxyl, formyl, cyano or carboxyl and also esters or salts thereof, carbamoyl, sulfo, sulfamoyl, nitro, nitroso, amino, phenyl, C₁-C₅-alkyl, C₁-C₅-alkoxy or C₁-C₅-alkylcarbonyl and two R⁷² radicals at a time or two R⁷³ radicals at a time or R⁷² and R⁷³ may be linked together pairwise via a [—CR⁷⁴R⁷⁵—]ₘ bridge, where m is 1, 2, 3 or 4, and R⁷⁴ and R⁷⁵ are the same or different and denote carboxyl, esters or salts thereof, phenyl, C₁-C₅-alkyl, C₁-C₅-alkoxy or C₁-C₅-alkylcarbonyl and one or more nonadjacent [—CR⁷⁴R⁷⁵—] groups may be replaced by O, S or an optionally C₁-C₅-alkylsubstituted imino radical and two adjacent [—CR⁷⁴R⁷⁵—] groups may be replaced by one [—CR⁷⁴═R⁷⁵—] group.

27. The oxidizing system according to one or more of claims 1-12 which is characterized in that the oxidation-enhancing compounds are compounds of the general formulae (XXXI), (XXXII) or (XXXIII) 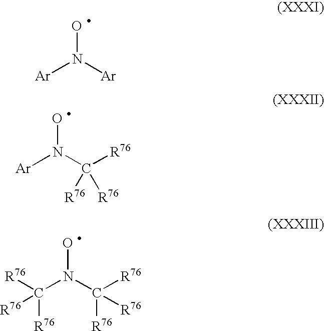
where
Ar is a univalent homo- or heteroaromatic mono- or binuclear radical and where this aromatic radical may be substituted by one or more, identical or different R⁷⁷ radicals, where R⁷⁷ denotes halogen, formyl, cyano, carbamoyl, carboxyl, esters or salts thereof, sulfo, esters or salt thereof, sulfamoyl, nitro, nitroso, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters or salts thereof, and
where the phenyl, carbamoyl and sulfamoyl radicals may be unsubstituted or singly or multiply R⁷⁸ substituted, the amino radical may be singly or doubly R⁷⁸ substituted and the aryl-C₁-C₅-alkyl, C₁-C₁₂-alkyl, C₁-C₅-alkoxy, C₁-C₁₀-carbonyl, carbonyl-C₁-C₆-alkyl radicals may be saturated or unsaturated, branched or unbranched and may be singly or multiply R⁷⁸ substituted,
where R⁷⁸ may occur one or more times and in each occurrence is the same or different and denotes hydroxyl, formyl, cyano or carboxyl and also esters or salts thereof, carbamoyl, sulfo and also esters and salts thereof, sulfamoyl, nitro, nitroso, amino, phenyl, C₁-C₅-alkyl, C₁-C₅-alkoxy or C₁-C₅-alkylcarbonyl, and
R⁷⁶ in each occurrence is the same or different and denotes halogen, hydroxyl, mercapto, formyl, cyano, carbamoyl, carboxyl and also esters or salts thereof, sulfo, esters or salts thereof, sulfamoyl, nitro, nitroso, amino, phenyl, aryl-C₁-C₅-alkyl, C₁-C₁₂-alkyl, C₁-C₅-alkoxy, C₁-10-carbonyl, carbonyl-C₁-C₆-alkyl, phospho, phosphono or phosphonooxy and also esters or salts thereof, and
R⁷⁶ may also denote hydrogen in the case of bicyclic stable nitroxyl free radicals (structure XXXIII), and
where the carbamoyl, sulfamoyl, amino, mercapto and phenyl radicals may be unsubstituted or singly or multiply R⁷⁹ substituted and the aryl-C₁-C₅-alkyl, C₁-C₁₂-alkyl, C₁-C₅-alkoxy, C₁-C₁₀-carbonyl, carbonyl-C₁-C₆-alkyl radicals may be saturated or unsaturated, branched or unbranched and may be singly or multiply R⁷⁹ substituted, where R⁷⁹ in each occurrence is the same or different and denotes hydroxyl, formyl, cyano, carboxyl, esters or salts thereof, carbamoyl, sulfo, esters and salts thereof, sulfamoyl, nitro, nitroso, amino, phenyl, C₁-C₅-alkyl, C₁-C₅-alkoxy or C₁-C₅-alkylcarbonyl and two R⁷⁸ or R⁷⁹ radicals at a time may be linked together pairwise via a [—CR⁸¹R⁸¹—]ₘ bridge, where m is 0, 1, 2, 3 or 4, and
R⁸⁰ and R⁸¹ are the same or different and denote halogen, carboxyl and also esters or salts thereof, carbamoyl, sulfamoyl, phenyl, benzoyl, C₁-C₅-alkyl, C₁-C₅-alkoxy or C₁-C₅-alkylcarbonyl and one or more nonadjacent [—CR⁸⁰R⁸¹—] groups may be replaced by O, S or an optionally C₁-C₅-alkyl-substituted imino radical and two adjacent [—CR⁸⁰R⁸¹—] groups may be replaced by one [—CR⁸⁰═CR⁸¹—], [—CR⁸⁰═N—] or [—CR⁸⁰═N(O)—] group.

28. The oxidizing system according to one or more of claims 1-12 which is characterized in that the oxidation-enhancing compounds are compounds of the general formulae (XXXIV) and (XXXV) 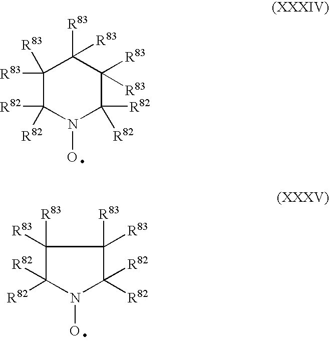
where
R⁸² in each occurrence is the same or different and denotes phenyl, aryl-C₁-C₅-alkyl, C₁-C₁₂-alkyl, C₁-C₅-alkoxy, C₁-C₁₀-carbonyl or carbonyl-C₁-C₆-alkyl, where the phenyl radicals may be unsubstituted or singly or multiply R⁸⁴ substituted and the aryl-C₁-C₅-alkyl, C₁-C₁₂-alkyl, C₁-C₅-alkoxy, C₁-C₁₀-carbonyl and carbonyl-C₁-C₆-alkyl radicals may be saturated or unsaturated, branched or unbranched and may be singly or multiply R⁸⁴ substituted, where R⁸⁴ may occur one or more times and in each occurrence is the same or different and denotes hydroxyl, formyl or carboxyl and also esters or salts thereof, carbamoyl, sulfo and also esters and salts thereof, sulfamoyl, nitro, nitroso, amino, phenyl, benzoyl, C₁-C₅-alkyl, C₁-C₅-alkoxy or C₁-C₅-alkylcarbonyl, and
R⁸³ in each occurrence is the same or different and denotes hydrogen, hydroxyl, mercapto, formyl, cyano, carbamoyl, carboxyl and also esters or salts thereof, sulfo and also esters or salts thereof, sulfamoyl, nitro, nitroso, amino, phenyl, aryl-C₁-C₅-alkyl, C₁-C₁₂-alkyl, C₁-C₅-alkoxy, C₁-C₁₀-carbonyl, carbonyl-C₁-C₆-alkyl, phospho, phosphono or phosphonooxy and also esters or salts thereof, where the carbamoyl, sulfamoyl, amino, mercapto and phenyl radicals may be unsubstituted or singly or multiply R⁷⁸ substituted and the aryl-C₁-C₅-alkyl, C₁-C₁₂-alkyl, C₁-C₅-alkoxy, C₁-C₁₀-carbonyl and carbonyl-C₁-C₆-alkyl radicals may be saturated or unsaturated, branched or unbranched and may be singly or multiply R⁷⁸ substituted and one [—CR⁸³R⁸³—] group may be replaced by 0, an optionally C₁-C₅-alkyl-substituted imino radical, a (hydroxy)imino radical, a carbonyl function or an optionally R⁷⁸ mono- or disubstituted vinylidene function and two adjacent [—CR⁸³R⁸³—] groups may be replaced by one [—CR⁸³—CR⁸³—] or [—CR⁸³═N—] or [—CR⁸³═N(O)—] group.

29. The oxidizing system according to one or more of claims 1-12 which is characterized in that the oxidation-enhancing compounds are compounds of the general formulae (XXXVI): 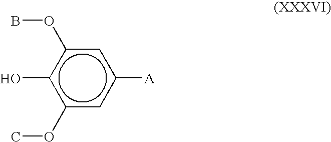
where
A denotes a -D, —CH═CH-D, —CH═CH—CH═CH-D, —CH═N-D, or —N═CH-D group, where D denotes a —CO-E, —SO₂-E, —N—XY or —N⁺—XYZ group wherein E denotes either hydrogen, hydroxyl, a —R or —OR radical and X, Y and Z are the same or different and hydrogen or likewise a —R radical, where R is a C₁-C₁₆-alkyl radical, preferably a C₁-C₈-alkyl radical, and alkyl is in each case saturated or unsaturated, straight-chain or branched and optionally carboxyl, sulfo or amino substituted; and
B and C are the same or different and represent a CₘH₂ₘ₊₁ group where 1≦m≦5.

30. The oxidizing system according to one or more of claims 1-12 which is characterized in that the oxidation-enhancing compounds comprise one of the following compounds:
3-amino-N-hydroxyphthalimide,
4-amino-N-hydroxyphthalimide,
N-hydroxyphthalimide,
3-hydroxy-N-hydroxyphthalimide,
3-methoxy-N-hydroxyphthalimide,
3,4-dimethoxy-N-hydroxyphthalimide,
4,5-dimethoxy-N-hydroxyphthalimide,
3,6-dihydroxy-N-hydroxyphthalimide,
3,6-dimethoxy-N-hydroxyphthalimide,
3-methyl-N-hydroxyphthalimide,
4-methyl-N-hydroxyphthalimide,
3,4-dimethyl-N-hydroxyphthalimide,
3,5-dimethyl-N-hydroxyphthalimide,
3,6-dimethyl-N-hydroxyphthalimide,
3-isopropyl-6-methyl-N-hydroxyphthalimide,
3-nitro-N-hydroxyphthalimide,
4-nitro-N-hydroxyphthalimide,
1-hydroxybenzotriazole and its salts,
1-hydroxybenzotriazole-4-sulfonic acid and salts thereof,
1-hydroxybenzotriazole-5-sulfonic acid and salts thereof,
1-hydroxybenzotriazole-6-sulfonic acid and salts thereof,
1-hydroxybenzotriazole-7-sulfonic acid and salts thereof,
1-hydroxybenzotriazole-4-carbonic acid and salts thereof,
1-hydroxybenzotriazole-5-carbonic acid and salts thereof,
1-hydroxybenzotriazole-6-carbonic acid and salts thereof,
1-hydroxybenzotriazole-7-carbonic acid and salts thereof,
violuric acid,
N-hydroxyacetanilide,
3-nitrosoquinoline-2,4-diol,
2,4-dihydroxy-3-nitrosopyridine,
2,6-dihydroxy-3-nitrosopyridine,
2,4-dinitroso-1,3-dihydroxybenzene,
2-nitroso-1-naphthol-3-sulfonic acid,
1-nitroso-2-naphthol-3,6-disulfonic acid, and methyl syringate.

31. A process for oxidizing oxidizable substances which is characterized in that the oxidizable substance is contacted with an oxidizing system according to one or more of claims 1-30.

32. A process for removing excess, unfixed dye from textile materials after a dyeing, preferably after a reactive dyeing, the process being characterized in that the dyed textile material is contacted with an oxidizing system according to one or more of claims 1-30 in at least one of the post-dyeing rinse steps.

33. The process according to claim 32 which is characterized in that the dyed textile material is contacted with the oxidizing system in at least one of the post-dyeing rinse steps by at least one of the rinse liquors having added to it
1) the three components of the oxidizing system individually in any desired order in succession or else individually and concurrently, or
2) initially the two components of the macrocyclic metal complex and of the oxidation-enhancing compound either individually and concurrently or else as a conjoint formulation and subsequently the oxidizing agent or
3) initially the two components of the oxidizing agent and of the oxidation-enhancing compound either individually and concurrently or else as a conjoint formulation and subsequently the macrocyclic metal complex.

34. Dyed textile material obtainable by the process according to claim 32 or 33.

35. A process for removing colored impurities from industrial wastewater, preferably from wastewater of the paper- or textile-processing industry, the process being characterized in that the industrial wastewater is contacted with an oxidizing system according to one or more of claims 1 to 30.

36. Wastewater, preferably wastewater of the paper- or textile-processing industry, obtainable by the process according to claim 35.

37. A process for lightening colored impurities on solid materials, preferably on textiles, paper or leather, the process being characterized in that the solid materials are contacted with an oxidizing system according to one or more of claims 1 to 30.

38. Solid materials, preferably textiles, paper or leather, obtainable by the process according to claim 37.
